(19) United States
(12) Patent Application Publication
(10) Pub. No.: US 2004/0110119 A1
(43) Pub. Date: Jun. 10, 2004

(54) Web-based knowledge management system and method for education systems

(76) Inventors: John R. Riconda, Northport, NY (US); Ann M. Savino, Bayshore, NY (US)

Correspondence Address: SCULLY SCOTT MURPHY & PRESSER, PC, 400 GARDEN CITY PLAZA, GARDEN CITY, NY, 11530

(21) Appl. No.: 10/654,034

(22) Filed: Sep. 3, 2003

Related U.S. Application Data
(60) Provisional application No. 60/407,701, filed on Sep. 3, 2002.

(51) Int. Cl. G09B 3/00

(52) U.S. Cl. 434/350; 434/362

(57) ABSTRACT

A web-based, knowledge management system for an education system that includes functionality for multi-tier data-gathering, data analysis, and data reporting capabilities that link, integrate, and output data at the student, classroom, school, district, and state governmental levels.

### CROSS REFERENCE TO RELATED APPLICATION

This application claims the benefit of U.S. Provisional Patent Application Serial No. 60/407,701 filed Sep. 3, 2002.

### BACKGROUND OF THE INVENTION

1. Field of the Invention

This invention relates to public education systems generally, and particularly to a comprehensive, real-time, interactive knowledge management system with integrated reporting features that is capable of capturing, managing, organizing and reporting of all data, at all levels of detail, that are deemed relevant to a student's academic growth and well being.

2. Discussion of the Prior Art

Public schools having students ranging from pre-Kindergarten to 12^{th} grade, for example, have implemented numerous operational systems over time to serve the needs of individual departments or functions. These disparate systems usually operate independently from one another, making it difficult to “manage the disconnect”. For example, individual school districts have adopted numerous operational systems including, but not limited to, transportation, special education, student management, classroom management, integrated learning systems, census, registration, discipline, health, nutrition, reporting, etc. The initial set up of these operational systems involves an export of student information from a primary student management (or enrollment) system. That data are usually imported into each operational system at the beginning of the school year (after the grade advancement process has been completed). From that point on, none of the systems “talk” to one another. Each of these specialized operational systems includes some information about students. Individually, each of these systems serve a purpose but without a competent Information Technology (IT) staff charged with the responsibility of tying the information systems together, there is no logical connection between the data contained in each system.

Furthermore, students are typically assigned different ID numbers in each operational system. Because there is no communication between the primary student management (enrollment) system and the various operational systems, it is likely that districts will unintentionally produce reports reflective of students who are no longer enrolled in the district. The margin of error is therefore greatly increased in districts with high student mobility rates. It is the case that most systems that assign different student ID numbers make it nearly impossible for the casual user to aggregate data reliably across all systems. The resulting data outputs from these systems are almost certainly skewed when they are combined for reporting purposes. Worse yet, neither the magnitude nor the direction of the skew is easily quantifiable.

Moreover, currently, data pertaining to students' performance such as grades, participation in extracurricular activity, health, attendance, mobility status, disciplinary actions, etc., either are being captured by the school districts inaccurately from the onset or, are not currently being collected in school districts at all. It is contended that student data is not currently being captured at the lowest level of detail at the district level and thus, aggregate data reported by each district are inherently inaccurate. One problem that exists is that low-level data currently captured in school districts is wrong. Unfortunately, current methods for capturing data are redundant and inconsistent and aggregate data reporting is largely a manual process.

For instance, recently, an intense, research-based study of local, state and federal interrelationships impacting public educational institutions was conducted and certain findings were concluded:

The methods used to compile Local Education Agency Program (LEAP) reports (e.g., in New York State) were found to be largely manual—with regard to both compiling data and the sources of baseline information. Further, it is verified that LEAP data are not contained in one single system. Typically, school district superintendents do not have the luxury of calling upon skilled Information Technology (IT) professionals to prepare reports such as Local Education Agency Program (LEAP) report; and, because of the complexities associated with gathering and interpreting data prior to submission for the LEAP report, this task usually cannot be delegated to clerical staff. Additional concerns include the quality of the LEAP data intended to populate a data warehouse for the state, i.e., LEAP data was already flawed. Further, with respect to the methods used to track Academic Intervention Services (AIS), there currently exists no database or mechanism to track student progress.

Increasingly, successful student outcomes are defined by, and tied to, education reforms. They are in turn directly impacted by financial and other data-driven correlations, which are ultimately based on data provided by individual school districts. For example, in some states, a Regents diploma is required for all graduating students as will be a passing grade on a National Assessment Measure soon to be required for graduation across the nation. Further, in some states, students who are at risk of not passing standardized tests are entitled to supplemental academic and support services. Unlike subsidies for Special Education programs, the costs associated with providing Academic Intervention Services (AIS) are primarily borne by the local district. If students are unable to meet the Regents graduation requirements, districts are now obligated to provide education for all students until the age of 21. Now more than ever, district administrators are seeking direct correlations between program expenditures and the academic growth of students being served by those programs. This information must be available in an integrated fashion to support comprehensive analysis of program effectiveness. Flawed data, however, lead to flawed conclusions, which generate poor decisions. Therefore, data-driven conclusions may actually impede progress and limit success, since the required data (whether aggregate or detail-level) are either inaccurate, inaccessible, or both. In the end, skewed data are highly likely to have a negative impact on education/school program funding and compliance in meeting instructional objectives.

Moreover, data pertaining to funding sources are not usually maintained in a primary student information system. The relevant data are typically derived through a manual review process involving comparisons of numerous printed reports gathered from numerous program coordinators.

In view of the foregoing, it would thus be highly desirable to provide a “better” student management system that is designed to capture the kinds of data that are considered useful at all levels of detail (e.g., the class room level) and render integrated data reporting more feasible.

It would additionally be highly desirable to provide a legacy student information management system capable of addressing workflow patterns and rendering integrated data reporting more feasible.

It would further be highly desirable to either replace current student management systems or enhance existing systems by offering a web-based front-end.

It would further be highly desirable to provide Web-Technology Structures that facilitate State and Local Education Agency Reporting through Performance-Based Accountability Systems and Comparisons of Schools and Subsets of Student Populations.

It would further be highly desirable to provide a web-based system to improve the types and manner in which data are being captured while also identifying opportunities for process improvement, business process redesign and policy changes.

It would further be highly desirable to provide a web-based system to organize and distribute data in a manner that supported the needs of the classroom teacher, various school administrators, and the school district as a whole and also insured internal consistency of the data.

There are presently three products on the market addressing school system management OpenDistrict by Chancery, PowerSchool by Apple, and SASI by NCS Pearson. PowerSchool is a completely web-based system originally designed to run on a Mac Platform. The system focuses on building the Family/School Connection. However, it is not designed to be administered by a Regional Information Center (RIC) and although it includes a gradebook, it is not an integrated gradebook, nor does it tie in learning standards or curriculum elements, nor does it embed national and state reporting codes into the system logic. Chancery Open District consolidates data gathered from WinSchool and MacSchool school sites and stores the data in a central repository; however, it is not a real-time application and it is not designed to be administered by a Regional Agency. Furthermore, Chancery's system does not embed National and State codes or learning standards into the system logic. NCS SASI does address student testing, however, not in an integrated fashion. Districts are not able to embed local learning standards, performance indicators and key ideas into the structure, nor are federal and state reporting codes embedded into the system. While these products are leaders in the field and have been delivering student management solutions for many years, none of these products combine administrative and instructional tasks and none embed national and state reporting codes within the system logic. Therefore, none can achieve the level of integration that is necessary to satisfy reporting and data aggregation at all levels (local, state and federal).

It would thus be further highly desirable to provide a robust web-based application service provider (ASP) application that will be supported by Regional Information Centers in each state utilizing a system designed to track a student throughout his/her entire academic lifecycle while integrating State and Federal reporting codes at the lowest level of detail. This system would provide on-demand, comprehensive, integrated reporting capabilities without disruption or intrusion, at the local level.

The promulgation of the No Child Left Behind Act of 2001 (NCLB)(Public Law 107-110) represents an education reform plan with sweeping changes and ensures the federal government's role in kindergarten-through-grade-12. The NCLB act includes the four basic education reform principles: stronger accountability for results, increased flexibility and local control, expanded options for parents, and an emphasis on teaching methods that have been proven to work by institutionalizing measurements as a means of program assessments. The national movement toward higher academic standards has introduced a new layer of complexity to school district reporting requirements. Not only are districts responsible for reporting aggregate attendance, demographic and exam results, but they must also track student progress over multiple years and through multiple school buildings. Because reimbursement formulas are increasingly complex and continuing to evolve, public school administrators must be prepared to turn-on-a-dime in response to formula changes.

As public school finding is now also dependent on the district's ability to demonstrate acceptable levels of academic growth for all enrolled students, failure to effectively monitor and utilize key data in a predictive manner is likely to have a negative impact on program funding as well as the effectiveness of existing instructional programs. Instructional leaders and business officials must have access to low-level data in an integrated fashion. In order to measure program effectiveness and/or to predict potential cost/benefits relationships associated with instructional program modifications, the underlying data systems must be integrated beyond traditional domains. Current operational systems do not support this paradigm shift.

It would be highly desirable to provide a comprehensive information management system that integrates data beyond traditional domains, and particularly, a comprehensive information system that support the goals and objectives of classroom teachers, state and local agencies as well as the mandates of the United Stated Department of Education in a manner that will lead to the improvement of education. In the prior art, school administrators and state agencies have attempted to consolidate data into data marts and/or into data warehouses in an attempt to bridge student system data with performance data. The major limitations to this approach were as follows:

Since Social Security numbers cannot be used to identify students due to confidentiality issues, and since there is currently no other ID used to identify students uniquely, data cannot be easily aligned between systems—especially for students with common surnames and those frequently moving from school district to school district. (Ironically, those are the students in most need of monitoring.)

Longitudinal statistics are less reliable because students IDs often change as a student is grade advanced.

Even when proper associations are made, data warehouses only contain snapshots of data. Therefore even with the most powerful analysis tools, it is impossible to “drill down” to the lowest level of detail because those details do not exist.

A data warehouse will capture a student's current status, at the time of the export, but it will not show the student's activity throughout the years. Even when data warehouses are able to connect the data, they are not operational systems, therefore, there is no capability to interact with the system.

### SUMMARY OF THE INVENTION

Accordingly, it is an object of the present invention to provide a comprehensive, web-based knowledge management system for an educational system that includes functionality for multi-tier data-gathering, data analysis, and data reporting capabilities that link, integrate, and output data at the student, classroom, school, district, and state levels.

It is another object of the present invention to provide a comprehensive, web-based knowledge management system that may be continuously updated and incorporates the No Child Left Behind Act regulations and model standards and guidelines as they are developed, enacted, and adopted.

It is yet another object of the present invention to provide a comprehensive, web-based service that is a real-time, interactive, best practice integrated knowledge management system for K-12 having functionality for providing: Micro-Level Student Profiling and Diagnostics; Student Scheduling; Student-Needs-Based Curriculum and Instruction Development; Student, School, District, and State-Based Performance Assessment; Federal, State, and District Standards-Linked Performance Reporting; and Student-Based Performance Improvement and Management.

It is a further object of the present invention to provide a web-based service intended for public and charter school use and which by utilizing a web-based operational system, facilitates the aggregation of data programmatically by the appropriate local reporting agency based on the guidelines established by the respective state or region with little or no disruption at the school district level. This system will afford flexibility at the local level while providing regional performance-based aggregate reports as an integrated system feature.

It is another object of the present invention to provide a web-based service that provides a web-interface (either as a complete system or as an overlay to existing student management systems) that generates performance reports programmatically based on the guidelines established by each state or region with little or no disruption at the school district level.

It is another object of the present invention to provide a web-based system to improve the types of data and manner in which data are being captured, while also identifying opportunities for process improvement, business process redesign and policy changes.

As gaps between current data collection methods and current reporting requirements are identified, the present invention enables modifications to the web interface to fill those gaps in accordance with recommendations from each state or region with little or no interruption at the school level.

It is yet another object of the present invention to provide a robust, scaleable application to run as an Application Service Provider model including many design and data structures that enables users (administrators) to access low-level data in an integrated fashion. In order to measure program effectiveness and/or to predict potential cost/benefits relationships associated with instructional program modifications, the underlying data systems must be integrated beyond traditional domains

It is yet another object of the present invention to provide a web-based service that provides functionality for enabling intelligent data collection, analysis, and management, and efficient reporting, in developing and implementing State-mandated Academic Intervention Services (AIS), including: the automatic identification of eligible students based on customized parameters; the tracking of a student's progress throughout the AIS program; the assessment of the program's effectiveness; and, generation of customized student AIS Reports.

School districts are forced to make academic decisions for every course being offered before a student can be scheduled into a class or time block. This means that for every block of time in the day, administrators and teachers know what the learning objectives are for this time period. Teachers can be assessed based on students' academic growth in their classroom. Districts must have the means to measure adequate yearly progress as described in the federal “No Child Left Behind” act. Thus, the present invention takes an approach of ensuring academic accountability at the classroom and district levels. By aligning academic standards to every single course offering and tying those standards to well crafted, academically focused report cards and progress reports—an extremely valuable academic measurement tool is produced. Since these tools are crafted locally yet required to be aligned to state and federal learning standards through the use of the present invention, school districts have the ability to assess students at an individual basis without changing their existing process or adding additional expense for testing tools.

Thus, in a preferred implementation, the present system of the present invention receives and stores all state academic standards and performance indicators. The system ties in federal academic standards and performance indicators (benchmarks) and allows school districts to add local academic standards while forcing alignment of local academic standards. The system further allows schools to synthesize, combine and apply federal/state/local learning standards to individual course objectives, thus eliminating redundancy or “fuzzy” academic objectives—or deviations to conform to nationally normed tests. The system of the present invention recognizes that the only means teachers have to evaluate students at an individual level is through interim reports and report cards. In accordance with the invention, by transforming the traditional interim reports and report cards into true academic assessment tools—school districts have the ability to synthesize the feedback of their teaching professionals.

Further, the system of the present invention provides focused academic reports to parents/guardians, thus parents know exactly how to help their children grow academically.

Advantageously, the comprehensive, web-based student management system of the present invention brings order to a local school districts' workflow and forces compliance with State and Federal Regulations. Furthermore, it enables public school administrators to carry out their current fiduciary educational and administrative responsibilities, meet the increasing governmental reporting requirements and, also establish a flexible, scalable decision support platform to sustain effective performance in an increasingly complex environment. Essentially the complete program of data collection and use will lead to the improvement of education systems nationwide.

### BRIEF DESCRIPTION OF THE DRAWINGS

Further features, aspects and advantages of the apparatus and methods of the present invention will become better understood with regard to the following description, appended claims, and accompanying drawings where:

FIG. 1(a) is a diagram illustrating the process for constructing and maintaining a knowledge management system for a school district according to the invention;

FIG. 1(b) is a diagram illustrating an Internet/Web-based communications environment employing the knowledge management system of the invention;

FIGS. 2(a)-2(b) depict an exemplary home page display interface 100 providing a menu framework 102 providing a school district staff member or administrator having to navigate through or set-up the school knowledge management system according to user permissions;

FIGS. 3-6 depict various exemplary web-based display interfaces providing functionality for setting up a household and registering students within the eSD® system;

FIGS. 7(a)-7(c) depict various exemplary web-based display interfaces providing functionality for taking class attendance within the eSD® system;

FIG. 8(a) illustrates a flow diagram of the daily closeout process for the attendance management sub-system thread according to the present invention and FIG. 8(b) illustrates the closeout default entry window for establishing a daily attendance closeout criteria;

FIGS. 9(a)-9(f) depict various exemplary web-based display interfaces enabling a teacher to enter grades and FIG. 9(g) illustrates an exemplary report card for a student generated via the grade entry system depicted in FIGS. 9(a)-9(f);

FIG. 10 illustrates an exemplary web-based display interface providing a list of students in a particular school;

FIG. 11 illustrates an exemplary web-based display interface providing the integrated Student Profile view according to the invention;

FIG. 12 illustrates an overview of an instructional support program process implemented according to the system of the invention;

FIG. 13 illustrates an exemplary web-based display interface providing a list of assessments and measures that are available to an example AIS program and maintained by the system of the present invention;

FIG. 14(a) illustrates an exemplary display interface providing an exemplary candidate report detailing students potential eligible for receiving AIS services and, FIG. 14(b) illustrates a corresponding Student View of a selected student revealing a recommendation for eligibility;

FIG. 15(a) illustrates an exemplary web-based display interface providing functionality for enabling the set up of a school district in accordance with State and Federal reporting requirements;

FIGS. 15(b)-1 5(c) illustrates an exemplary web-based display interface enabling student batch scheduling;

FIG. 15(d) illustrates an exemplary web-based display interface enabling creation of student groups;

FIG. 16(a) illustrates an exemplary enrollment record generated and maintained by the system of the invention; and FIG. 16(b) illustrates an exemplary enrollment record illustrating a school district a student has attended in the past, or will be attending in the future;

FIG. 17 illustrates an exemplary status history record for a student that details the types of support services that the student has received;

FIG. 18 illustrates an exemplary composite journal enabling a user to view all entries of anecdotal information entered and concerning students in a school;

FIGS. 19(a)-19(g) depict the generation of various report in compliance with a governmental authority which may be automatically generated according to the invention;

FIG. 20 illustrates an exemplary display interface enabling the presentation, selection, viewing and editing of all courses offered in the particular school;

FIG. 21 illustrates an exemplary display interface enabling the entry of a new course;

FIG. 22 illustrates an exemplary display interface enabling the presentation, selection, editing and modification of a Knowledge Area and the corresponding association with an academic standard;

FIG. 23 illustrates an exemplary display interface enabling the presentation, selection, editing and generation of a new school curriculum;

FIG. 24 illustrates an exemplary display interface enabling the entry of correct weighting factors for a school course;

FIG. 25(a) illustrates an exemplary display interface enabling the presentation, selection, editing and generation of assessments;

FIG. 25(b) illustrates an exemplary display interface enabling a user to define local Assessments and scoring methods for particular courses offered in a school district;

FIG. 25(c) illustrates an exemplary display interface enabling the entry of progress report comments and associated codes that may be added to the student's report card via the grade entry screen entry fields;

FIG. 26 illustrates an exemplary display interface enabling the presentation, selection, viewing and editing of all information pertaining to a school, including relevant codes;

FIG. 27(a) illustrates an exemplary Student Status display interface enabling the user and maintenance of student status codes for a school district and enabling a user to define a Status Code and, a Status Name;

FIG. 27(b) illustrates an exemplary Funding Source display interface enabling the use and maintenance of Funding Source codes that are in use in various school districts including functionality for defining a new Funding Source code;

FIG. 27(c) illustrates an exemplary Disability Codes display interface enabling the use and maintenance of Disability Codes that are in use in various school districts including functionality for defining new Disability codes;

FIG. 28 illustrates an exemplary display interface enabling the generation of an, Enrollment report, for an example school, showing the tally of students on the basis of student codes;

FIG. 29(a) illustrates an exemplary display interface enabling the initiation of a school or school district-wide search for students of a particular Status and FIG. 29(b) illustrates an example display screen providing example search results for students associated with the Emergency Housing status code;

FIG. 30(a) illustrates an exemplary display interface enabling the automatic generation of a summary report of the student attendance status by school period;

FIG. 30(b) illustrates an exemplary display interface enabling the automatic generation of an Attendance Reconciliation Report by school period;

FIG. 30(c) illustrates an exemplary pop-up display interface enabling the editing of a student's attendance, including providing possible excuse reasons from drop-down lists;

FIG. 30(d) illustrates an exemplary Students with Excessive Absences screen display which details all students having a total number of excessive absences for a defined time period;

FIG. 30(e) illustrates an exemplary All Absences by Date screen display that details all student absences on a particular date;

FIG. 30(f) illustrates an exemplary Attendance Reason Search Report that enables the determination and viewing of trends in school absences;

FIG. 31(a) illustrates an exemplary display interface enabling the presentation, selection, viewing and editing of all information pertaining to a planned field trip;

FIG. 31(b) illustrates an exemplary display interface enabling a mass group assignment of students to a school event, such as a planned field trip;

FIG. 31(c) illustrates an exemplary pop-up display such as shown in FIG. 31(b) that illustrates attendance at a planned field trip for a selected student from a student view of FIG. 11;

FIG. 32(a) illustrates an exemplary display interface enabling the presentation, viewing and editing of all information pertaining to individual scheduling;

FIG. 32(b) illustrates an exemplary web-based display providing a preview mode, showing only scheduled classes for a particular student;

FIG. 32(c) illustrates an exemplary web-based display providing a student's schedule by term, e.g., fall semester, or by course as shown in FIG. 32(d);

FIG. 33 depicts an overview of how the system of the present invention manages all of the data necessary to comply with Federal and state regulations and optimize revenue from grants and outside funding sources; and,

FIG. 34 depicts a Lunch Status Batch update list indicating all students eligible for receiving free or reduced lunch.

### DETAILED DESCRIPTION OF THE PREFERRED EMBODIMENT

The present invention is a comprehensive, web-based knowledge management system for schools and school districts. Referred to as eSchoolData®, the web-site and supporting technology provides functionality for supporting a multi-tier data-gathering, data analysis, and data reporting capabilities that link, integrate, and output data at the student, classroom, school, district, and state levels. By virtue of its “best practice” data management framework for student data collection, integration, analysis, and reporting, the Student Management System ensures full compliance with the Federal “No Child Left Behind” Act requirements. That is, the capabilities make the eSchoolData® system (eSD® system) the first software to track and integrate federal, state, and local education reporting requirements and performance standards.

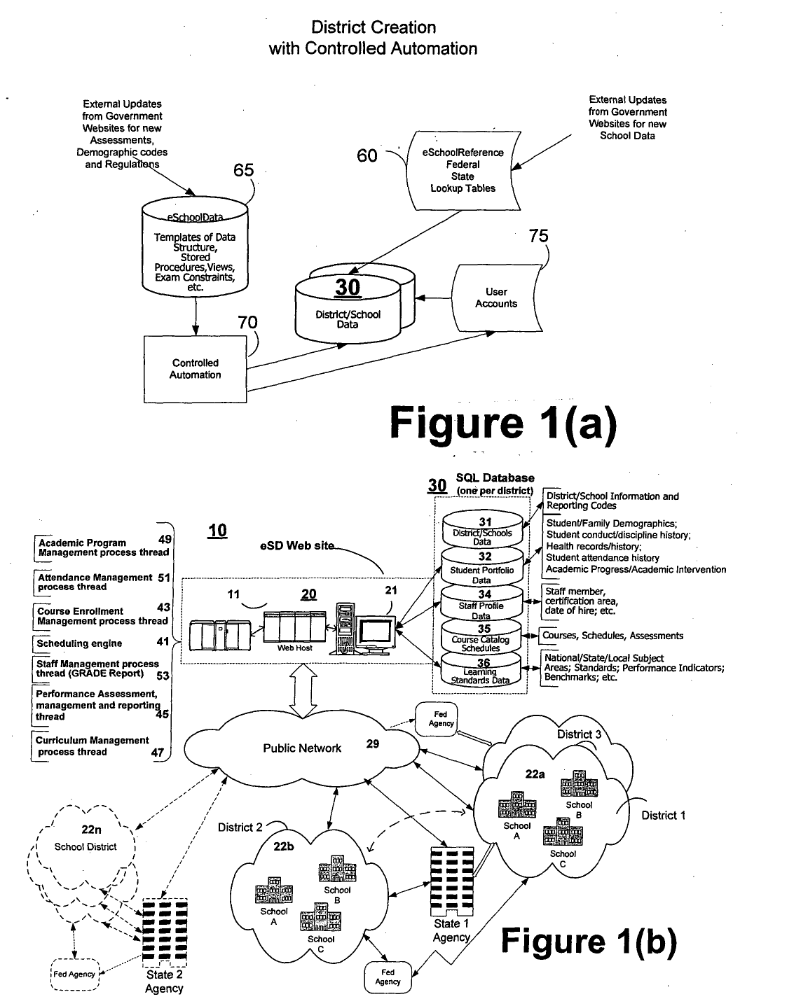

As shown in FIG. 1(a), in the creation of the knowledge management system of the invention, a separate database 30 is constructed and maintained by the eSD® system for each school district. Feeding database 30 is data from a datastore of tables 60 comprising the latest federal and state school codes (e.g., BEDS, NCES codes, school names, etc.). As depicted in FIG. 1(a), these tables 60 are continuously updated to maintain the latest version of all school codes. As will be explained, data from the federal and state look-up tables may be pushed down to any field within a defined application or system function as needed. An SQL server database 65 is provided that includes templates of the data structures that are used by each school district and stored procedures implementing eSD® system functionality. It also includes the latest federal and state assessments, demographic codes and regulations that are universally applicable which are additionally downloaded and stored in tables. These tables are continuously updated to maintain the latest version of all such data. Implementing Microsoft's Dynamic Transformation Services (DTS) 70, integration, formatting, and initializing security functions are automated. For example, DTS functions are implemented to receive data downloads from each state's web-site for storage in the district's database 30. Thus, the district template database 65 only actually receives the current state code data from the reference database depending upon the needs of the district, e.g., when a student is transferred from another state, that state's codes are retrieved to populate tables for the student in the transferee district. This adaptation of the Microsoft DTS process physically configures the databases to maximize response time and to provide data transfer efficiencies, and affords rapid deployment for new school districts. User Accounts 75 are further created in a mixed authentication mode, using both MS Windows and SQL, and also internal security procedures, adding an additional layer of protection. This user account model facilitates authentication during the creation stage and during the ongoing administration. For example, the accounts database leverages technology such as Microsofts' Global Unique Identifier, e.g., that maps user teachers, staff, administrators, etc. against a uniquely assigned 36-bit character to enable access to the district's database. This technology additionally enables the management and use of the data for many years and a novel process is implemented to achieve a large number of unique student ID assignments per district per unit time.

Resulting from the district set-up/maintenance process depicted in FIG. 1(a) is the eSD® system architecture and web-site 20 shown in FIG. 1(b) that provides the comprehensive, on-line knowledge management system for schools and school districts according to the invention. FIG. 1(b) particularly illustrates the Internet/Web-based communications environment 10 employing the eSD® system web-site 20 providing the comprehensive, on-line student management system for schools and school districts according to the invention. The web site 20 is entered into by members via a supported web-browser (URL at https://www.eschooldata.com), to access the student management database and reporting services provided on-line over a public network or Internet 29, that includes one or more web/database servers 11 comprising application and database software components as will be described in greater detail herein.

According to the invention, school members (represented, for example, by teachers, principals, etc) and school district members (represented, for example, by superintendents, district administrators, etc.) 22a, 22b, . . . , 22n, are enabled to access the Web site 20 remotely via wired or wireless connections to the Web/Internet 29. Wired communications between the web site 20 and the school district member are via the public Internet in accordance with standard TCP/IP protocols and optionally, over a secure communications link, e.g., secure sockets layer (SSL), or similar protocol.

Preferably, solid security management at the application, network, and physical levels is provided, including SSL 128-bit data encryption and a customized system of user authentication and permission that accurately matches school district policies and workflow. It is understood that member users may access the Web/Internet via a personal computer/computing device, personal digital assistant, or like device implementing web-browser functionality, e.g., Netscape® or Internet Explorer 5.0®.

As depicted in FIG. 1(b), the web-site server 20 employs hardware and software components configured to facilitate data entry and generate reports. On the hardware side, the web-site is developed on a Microsoft.NET Platform, and includes Microsoft SQL Servers 11, 21 with SQL2000, or like equivalent databases 30. Preferably, these components are centrally managed, fully redundant high-speed data circuits and include high-performance server clusters for both database servers and web servers, that are fully load balanced and include a 24×7 intrusion alert and network attack monitoring system. Preferably, the system is scalable for school districts of all sizes and offers a menu of module configurations to suit the customized needs and budgets of every school district. In a preferred embodiment, the system is designed to distribute workload to different servers to optimize response time and to avoid data overload.

Software elements include, but not limited to: 1) domain controllers including: an Operating System (OS) component, e.g., such as Microsoft Windows 2000, Windows XP or greater, that is utilized in all computers in the production network to provide the basic software platform upon which all other software mechanisms operate; including the above-identified authentication process using both MS Windows and SQL; and, 2) application server provider components (ASP) which work in concert with SQL2000, or like query engine, to provide rapid development and access to a robust highly relational data platform with the security demanded by the type of data; and, including: Internet Information Services (IIS) which is a mechanism enabling files on a computer to be read by remote computers and particularly, is used to house, secure and present a web site to either the Internet or an intranet (private network); Component Services (COM+) which function as a repository of custom Dynamic Link Libraries (dll's) allow custom applications to perform actions in data sources foreign to the application, e.g., enabling a web page to query data on a database, or create a new member in Active Directory; and, Communication Services which include a server applications that enables various electronic communications including, e-mail, and, provide a messaging infrastructure. Preferably, the web-site 20 is structured to generate interactive web-pages, viewable by standard web-browsers, that enable users to navigate to many levels of detail. It is understood that each user of the eSD® system is given access only to those areas of the system that pertain to the user's job function. Although each school district database is comprised of many tables, the end-user is not overwhelmed by the enormity of the system because he can only access that which pertains to his job function. Additionally, the flexibility of the system design allows for custom implementations based upon the district's existing operational processes. This dramatically reduces both the training cost and process disruption during the information system migration.

With more particularity, the system diagram of FIG. 1(b) depicts the provision of an SQL database 30 for storing the many types of data maintained by the eSD™ system for a school district. In a preferred embodiment, the databases are self-contained databases such that each school district 22a, 22b, . . . , 22n has its own physical database 30. This facilitates distributed workload on different servers to optimize response time, facilitates data administration and trouble-shooting, and, avoids data overload. This provides an inherent security feature as it is impossible for one school district to corrupt another's data. The SQL database 30 maintained for a school district includes data including, but not limited to, the following:

District/School data 31 comprising District/School information and reporting codes, for example, federal and state ID codes that identify a type of school district, e.g., urban, rural, suburban, which is maintained as part of the district/school data, and helpful for a state or federal agency to conduct comparisons of schools and student populations; Student Portfolio Management data 32, including information such as Student/Family Demographics; Student conduct/discipline history; Health records/history; Student attendance History and Academic Progress/Academic Intervention. Particularly, the eSD® system's robust data schema and database engine stores and tracks virtually any and every data element about a student, captured and stored in a student record, according to a data content template customized at the school district level and, generate an output that is presented in a logical, meaningful manner. The eSD® system enables member users to add data for inclusion in the student portfolio database including, but not limited to: 1) Student/Family demographics, including pertinent information including language, ethnicity, etc.; 2) Student Conduct and Discipline History as eSD® system enables member users to add customized disciplinary events to a student's record and provide for easy examination of a student's disciplinary history; 3) Attendance History as the eSD® system provides extensive attendance management features that provide the school and school district with the following capabilities: the taking of real-time attendance from the classroom, providing information immediately to other system users, thereby being able to account for student locations at all times, and perform real-time reporting; the taking of attendance by period or daily, real-time or delayed; flexible reporting that allows for deeper analysis of attendance trends; and a group tracking and other features that allow for intelligent pattern recognition within attendance activity; 4) Health Records and History as eSD™ system enables member users to store and track pertinent student health information for easy viewing by appropriate school staff; and, 5) Academic Progress/Academic Intervention information as the eSD® system supports the various aspects of the Academic Intervention Services (AIS) specifications including whether a student is receiving or needs to receive additional instruction that supplements the general curriculum (regular classroom instruction) and/or other student support services needed to address barriers to improved academic performance. Although the intensity of such AIS services may vary, they are designed to respond to student needs as indicated through State assessments results and/or the district-adopted or district-approved procedure that is consistent throughout the district at each grade level. Further details regarding the the AIS setup, deployment, administration and reporting features of the eSD® system will be explained in greater detail herein; Staff Profile database 34 as the eSD® system's robust data schema and database engine can store and track virtually any and every data element about a staff member, such as a teacher, including data such as the certification area, date of hire, etc. Course Catalog Schedules 35 comprising information such as courses offered by the schools, Schedules, and Assessments; and, Learning Standards database 36 comprising information such as National/State/Local Subject Areas; Standards; Performance Indicators; Benchmarks; etc. Particularly, the eSD® system brings order to the local school districts' workflow and forces compliance with State and Federal Regulations and is a continuing development process that performs: 1) constant review of current and impending regulations and accountability requirements; 2) a modification of the database 30 and front end interface to ensure that all required data elements are being captured at the lowest level of detail, and in a manner such that the low level data elements become mandatory fields of entry (in this manner, all fields that are required for a State or Federal Accountability reporting, are REQUIRED fields of entry); and, 3) upgrades of data structures and ASP pages to the application to force compliance as regulations change. Accordingly, the eSD® system has incorporated federal and state requirements into standard workflow. In this effort the eSD® system manages the variety of codes by incorporating statistical codes from National Center for Education Statistics (NCES) to define ethnicity, poverty level, birth country, language, etc.; and, additionally manages disability codes—which combines federal, state and local codes; funding source codes—combines federal, state and local codes; and, custom codes that may be defined by each district. When a district defines additional codes, the eSD® system ensures that they end up in the right category.

As further shown in FIG. 1(b), there is a variety of process threads that provide the system functionality for a given district. These process threads include:

a Scheduling Engine process thread 41 that quickly and effectively configures a school district's schedule for the school semester or year, and automatically generates master schedules. The functionality enables the setting and tracking of who is teaching what/when and which students are enrolled in each course for a school. Data information settable includes semester patterns, meeting times, course weights, staff, teachers, credits, fees, locations, GPA, etc. The system knows where every student and staff member should be at every moment in time, and this information is integrated with academic objectives and performance; a Course Enrollment Management process thread 43 that provides a user with the ability to easily manage a student's schedule throughout the school year, including course change requests and student status and mobility changes; and, the ability to integrate course change requests into the eSD®'s comprehensive scheduling engine 41, providing a seamless solution to enrollment needs;

a Performance Assessment management and Reporting process thread 45 the provides the ability to store, view, and report on a wide array of student performance assessment data, e.g., on Local, State, and National Reference Tests. By leveraging its built-in grade book capabilities this eSD® sub-system additionally performs current and historic grade management, and, can easily generate report cards and transcripts, based upon school district-specific customized templates. This thread additionally provides customized K-12 progress reports with unlimited narrative options, mapped to National, State, and Local Performance Assessment Standards;

a Curriculum Management process thread 47 that provides the ability to develop standards-based learning experiences including the ability to quickly and easily create customized Local Standards; and, integrate local learning standards with State and National Standards in designing curricula and classroom instruction;

an Academic Program Management process thread 49 that provides the ability to quickly and easily establish groups and other configuration information to intelligently track and manage students in a variety of enrichment programs; and, provides administrative control that allows for easy evaluation of the effectiveness of each program over designated timeframes; and,

an Attendance Management process thread 51 that provides the ability to record and generate attendance records by the period and for a whole day; record absence reasons and absence status (excused, unexcused); summarize data for preparation of particular reports such as, for example, SA-129 which is used to report attendance statistics to New York State Education, and BEDS (Basic Educational Data System) report which is used to report enrollment totals and is broken down by, grade level, ethnicity, and gender. The BEDS report also contains statistics for suspended students; incorporates field-trip data into daily attendance processes; update tables with data required for state-reporting; optimizes. throughput by implementing set-based operations; automatically schedules and execute attendance to eliminate personnel involvement; supports a high degree of flexibility and customization for rules; and updates de-normalized reporting tables to maximize throughput for attendance reports; and,

a Staff Management process thread (GRADE Report) 53 that provides the ability to track teacher staff performance and a variety of other administrative tasks performed by staff members.

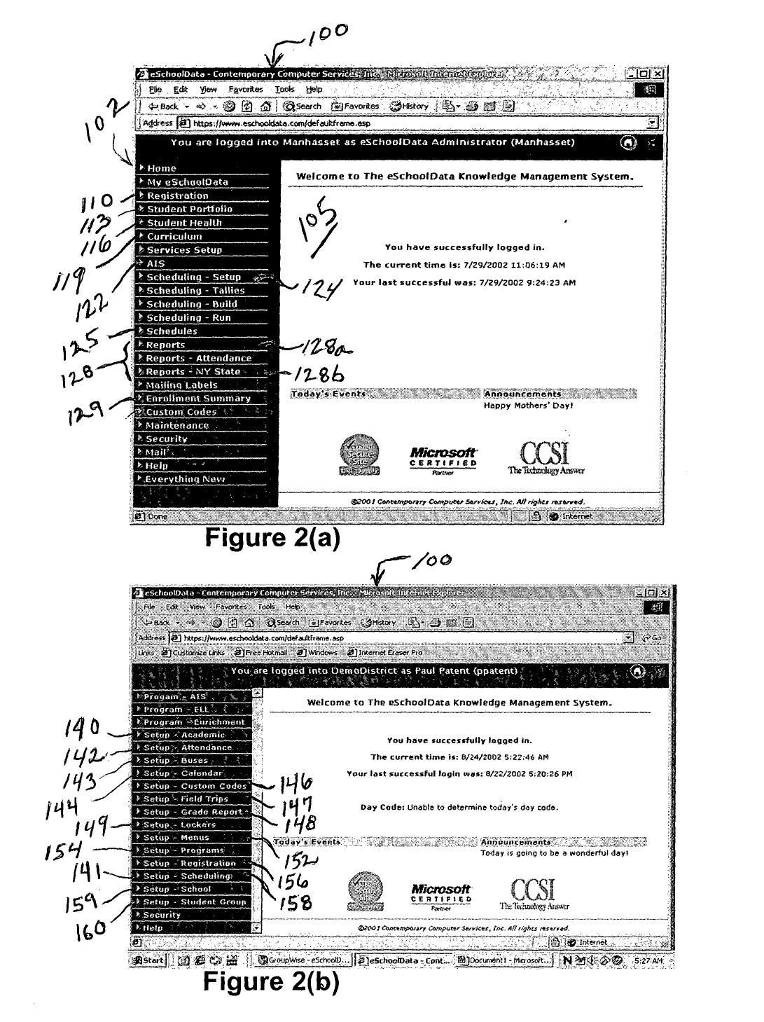

FIGS. 2(a) through 34 depict the various web-based interface display providing the functionality of the present invention. Upon logging in, the application is hosted centrally and users in school districts access it via a web browser. As mentioned, the eSD® system supports an extensive security model, allowing for nearly infinite fine-tuning of which groups and users access which functions. Particularly, a proprietary algorithm is implemented to manage security by associating users with web page. Features not accessible by a particular user will simply not appear on a display screen. Thus, it is understood that users' screens may not be identical. If reference is made to a particular button or navigation item or icon and it does not appear on the screen, the user does not have permission to access that feature.

FIGS. 2(a)-2(b) particularly depict an exemplary home page display interface 100 providing a menu framework 102 for navigating through the eSD® system. The various features of the eSD® system are organized as a menu according to a structure established by the district and individual menu items are features and functions located within each menu. A user selects a menu item, to expand the list of menu items available, and accesses that function/feature in the main display area 105 of the display window according to that logged-on user's permission. As shown in the exemplary screen of FIG. 2(a), main menu items include selections implementing functionality for enabling authorized end users to generate/enter data into, access and view database records including: Registration data 110; Student Portfolio data 113; Student Health record data 116; a School's Curriculum data 119; Student AIS data 122; Scheduling data and students Schedules 125; and Reporting data 128, for example, attendance reporting. Each of these functional areas will be explored in greater detail herein. FIG. 2(b) depicts further menu choices providing functionality enabling authorized end users to set up the student knowledge management system for a particular school district and particularly depicts the menu framework providing menu choices implementing functionality for enabling knowledge management set-up: of an Academic program 140; of a scheduling program 141; of an attendance sheet 142; of student assignment to buses 143; of an academic calendar; of custom code definition and maintenance 146; of Field Trips 147; of a grade report 148; of student lockers 149; of menus 152; of programs 154; of Registration 156; of Scheduling 158; of a school 159, and of a student group 160. Each of these functional areas will be explored in greater detail herein.

Referring to FIG. 2(a), with respect to the Registration data 110 menu choice, student profile data is first captured when the student registers and the eSD® system uses “Households” as one of the basic elements of student information. Students are grouped into households and students and guardians are added to households. This data formation allows a school district to send one mailing to a household even when there are multiple students within that household. It also allows for easier management of various exceptional situations, such as when a student residence is different from a guardian residence or the student is in foster care, etc.

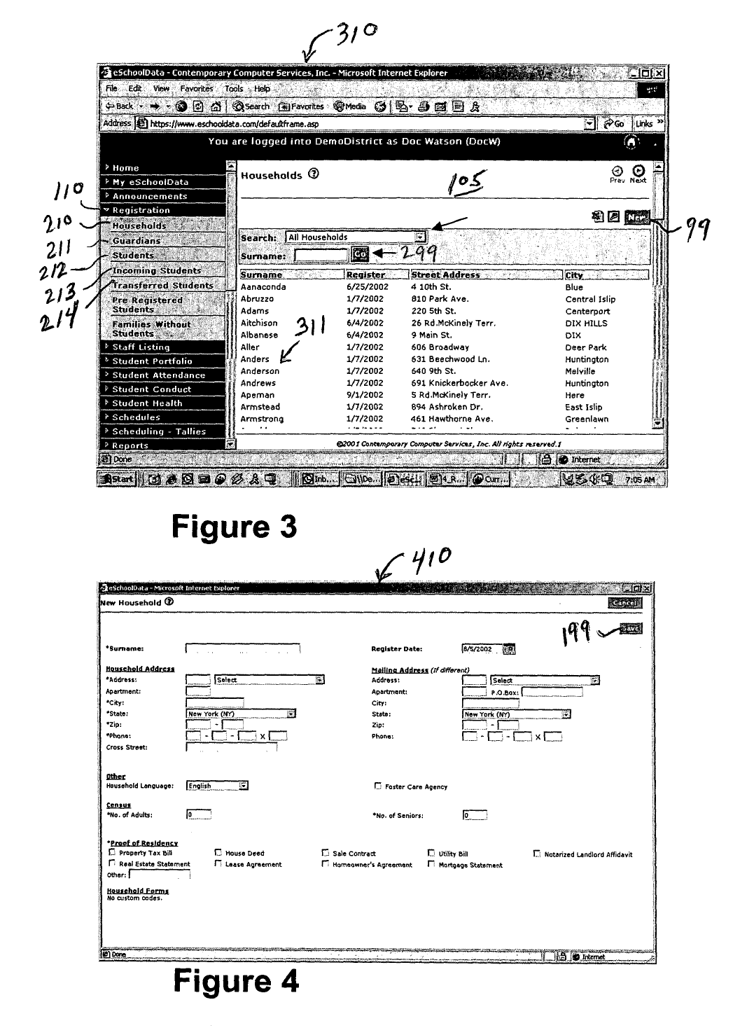

A student record cannot be entered until the household has been set up, a user thus may select the Registration menu item 110, and select the Households menu item choice 210 as shown in the exemplary screen display 310 of FIG. 3. Upon selection of Households menu item choice 210, the system presents in display screen a searchable list 311 of households already registered in the district. However, when there are several students within one household, the household information only has to be entered once. By clicking on the “New” button 99 in FIG. 3, an entry window 410 is displayed as shown in FIG. 4 that enables the addition of a new Household to the district. The exemplary screen display of FIG. 4 shows the type of data required to be entered for setting up a new household including a surname, residence address, household language, pertinent census information such as number of adults living at the residence, and proof of residency received, etc. When finished entering data, the user may click the “Save” button 199 to store the new household which would then appear in the list of households 311 in FIG. 3. Once the household has been established, the household may be located by searching via display or by entering the full or partial surname and clicking a “Go” button 299. Once the household is listed on the screen, the household entry may be clicked to open a new window with household information (not shown) and to which a new student may be added.

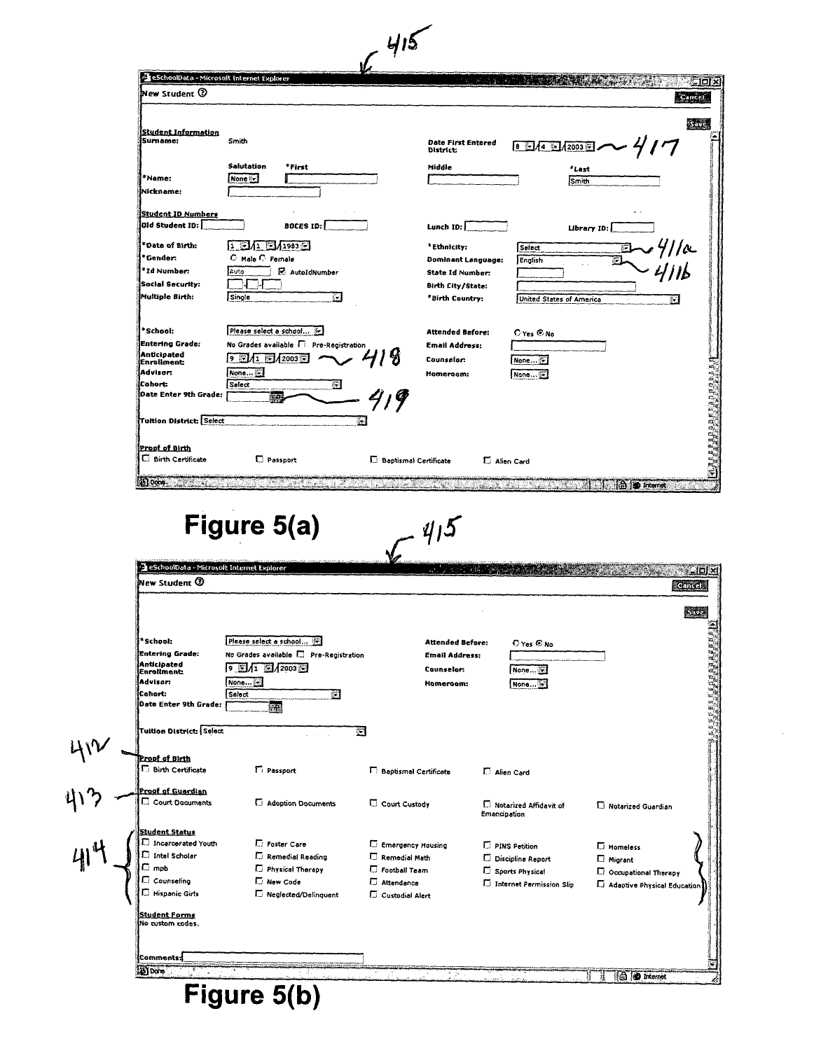

FIGS. 5(a) and 5(b) depict exemplary display screens 415 enabling entry of new student information, including entry fields for entering required data, including but not limited to: student name, Date of Birth, Gender, an ID number which is automatically generated for internal use by the eSD® system, a school selection, other relevant Student ID numbers, and the student's ethnicity and dominant language, and birth country, etc. Note that the system enables entry and maintenance of separate dates, e.g. a date 417 when the student first entered the district, the date of student enrollment 418 and the date 419 that the student will enter 9^{th} grade. The date that the student will enter 9^{th} grade is used for secondary reporting since, by educational convention, students are considered High School students from 9^{th} grade on regardless of the school building they attend. Note that by federal regulation, the “Birth Country” field is a required field. If the student's birth country is not the United States, there is an additional federal requirement that the school district request a copy of the INS entry form which will provide the date of the student's entry into this country. The eSD® system forces field validation in accordance with Federal and State reporting requirements, so that the system maintains the internal validity of the data and assures that reports prepared by the system will have the requisite information. For this reason, the data for ethnicity (Fed/State) 411a, dominant language (Fed/State) 411b, proof of birth (Local) 412, proof of guardianship (Local) 413, Program Status, (Fed/State/Local) and student statuses (Local) 414 are selected only from predefined choices. Other entry fields on the student registration screens are used to track various student statuses, membership in programs, funding sources, form submission status and group membership.

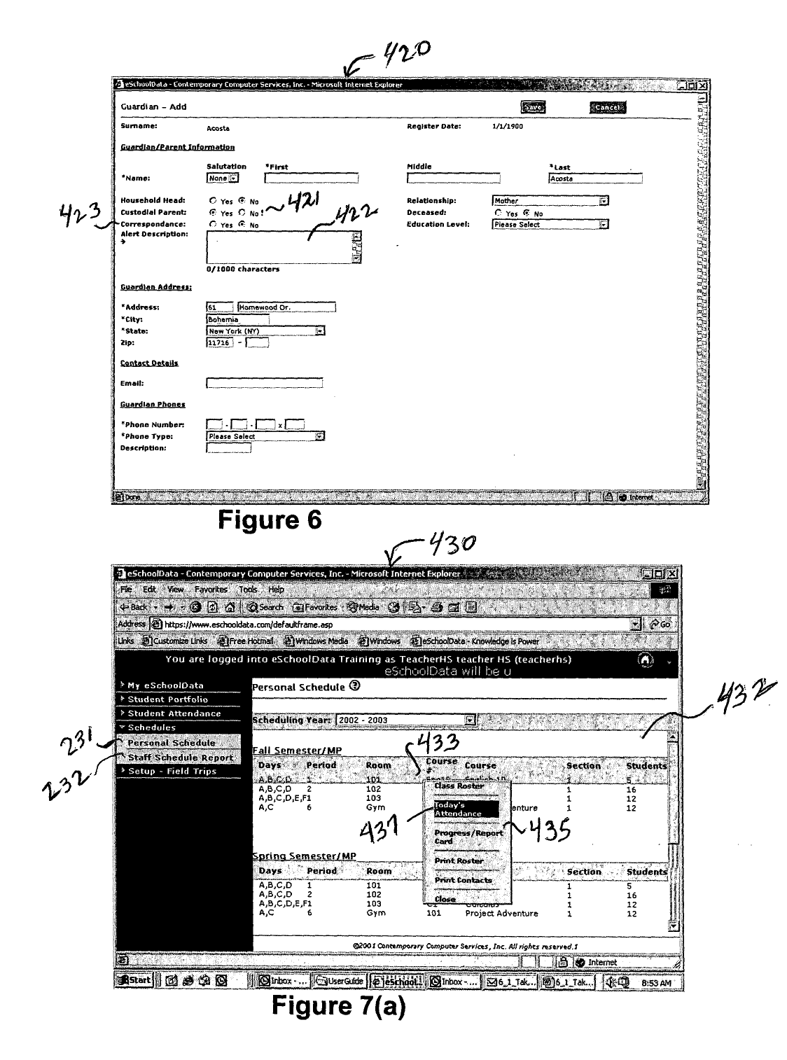

The eSD® system preferably stores guardian information separate from a household to allow for the greatest amount of flexibility when managing overall student information. Thus, referring back to FIG. 3, selection of “Guardians” menu choice 211 from the web-based display 310 will generate an entry window 420 providing a screen display enabling addition of a new guardian for the selected household including fields for adding basic guardian information, including at least one phone number for the guardian and, the guardian's employer information. As indicated in FIG. 6, the eSD® system provides the ability to identify the guardian as the Head of Household, the Custodial Parent, and to specify whether or not this guardian should receive correspondence. The custodial parent alert icon 421 and extreme alert comment boxes 422 are additionally used to assist a school in managing the relationship with this individual for the educational benefit of the student and to protect the district from possibly illegal acts, such as releasing a student to a non-custodial person, for example, who might be a potential abductor. The users' attention is drawn to the alert icon 421, and details of the alert may be written in the alert comments text box. Selection of a correspondence flag 423 in FIG. 6 will determine whether mailing labels and parent notifications are generated for this guardian in addition to the household. At times it may be necessary to add or edit a student's contact information. Thus, referring back to FIG. 3, selection of “Students” menu choice 212 from the web-based display 310 will provide a series of screen displays enabling access and viewing of Student Contact information. Further, in the event that a student transfers to another school either out of the state or within the current school district, the eSD® system provides functionality to ensure that the transfer is successfully completed. Selection of “Students” menu choice 212 from the web-based display 310 of FIG. 3 will provide a series of screen displays enabling entry of the appropriate information in required fields that includes a school type, the actual school if within the district, and a reason for the transfer. When transferring a student to another school within the district an additional step of accepting the student into the new school, is required. To perform this, a user selects Incoming Students menu choice 213 from the Registration web-based display 310 of FIG. 3 and selects the appropriate school. The user is then presented with a list of students currently transferred to the selected school. By selecting a particular student, there is presented a View Incoming Student screen that enables acceptance of the student into the school and effect the transfer of a student between district schools. In the event that a previously transferred student is returning to the district, there is a need to reenter the student information. The eSD® system provides functionality for putting back the original student records rather than re-create a new record by following steps provided in a series of screen display in response to clicking on the Transferred Students menu choice 214 from the web-based display 310 of FIG. 3 and complete the Un-transfer Student procedure by following functionality in that screen.

The eSD® system allows districts to input and manage a variety of attendance related information. Attendance rules are generally established by the school. For example, at the elementary school level, attendance may be taken once a day. However, at the secondary school level, attendance is taken each period, and a daily closeout process assigns a daily attendance status based on the periodic attendance statuses and the school's rules. Details of the attendance closeout process according to the invention will be described in greater detail herein.

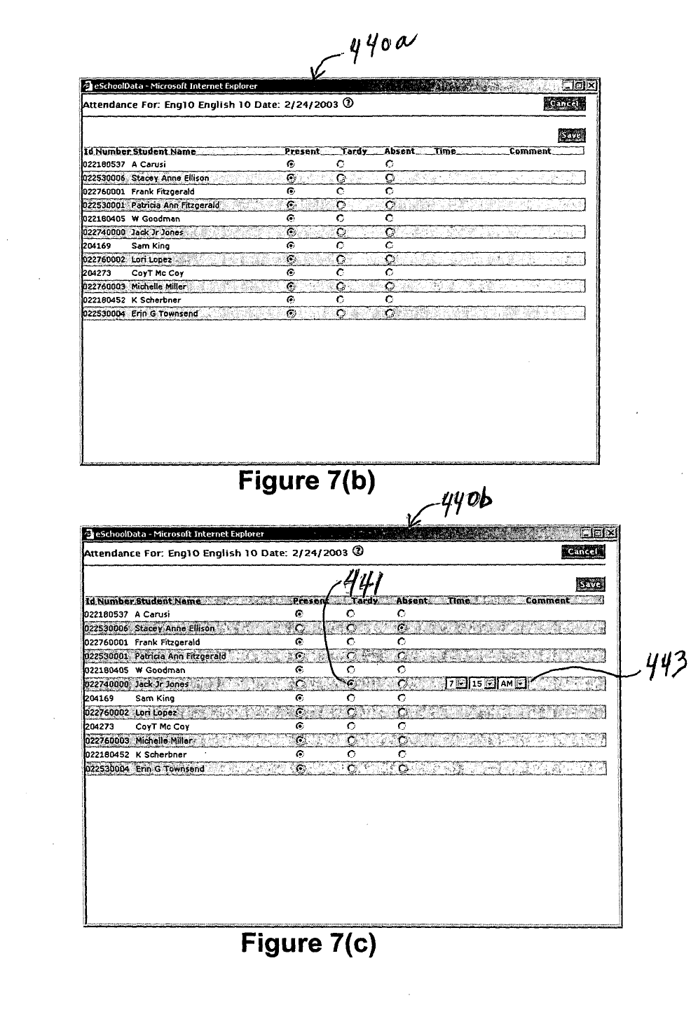

The eSD® system allows teachers or other appropriate users to enter period-by-period attendance records, in real time. Thus, upon selection of Schedules menu item choice 125 from FIG. 2(a), there is generated a screen display such as the exemplary screen display 430 shown in FIG. 7(a), providing menu screen choices including a “personal schedule” 231 which when selected, generates for the user (e.g. a teacher) a screen 432 displaying a list of courses assigned to the teacher. To access the attendance information for a class 433, the teacher selects the class for the current semester and a pop-up window 435 is generated that displays several options based on the user's permissions. The “Today's Attendance” option 437 may be selected from the pop-up window 435 which generates for display the current attendance information for the class as shown in the exemplary class attendance information screen display 440a of FIG. 7(b). Preferably, by default, all the students will be marked present, however a student may already be marked absent or tardy, if previously performed by a school attendance officer. That is, a member of the central office may have to enter class attendance information when, for instance, an assigned teacher is not available to do it. Thus, from generated screen display 430 shown in FIG. 7(a), a menu screen choice “staff schedule report” 232 is provided, which when selected, presents the same functionality for taking attendance as for the teacher. Whether performed by the teacher or administrator, a student's attendance status may be recorded by clicking the appropriate radio button, e.g. button 441, in corresponding class attendance screen 440b of FIG. 7(c). For instance, if a student is marked tardy, the time will default to 15 minutes after the beginning of the class, however, a teacher may enter the correct time via time entry drop-down menu 443. This information becomes immediately available to other system users, such as the attendance officer, who, in turn, may begin acting on this information appropriately.

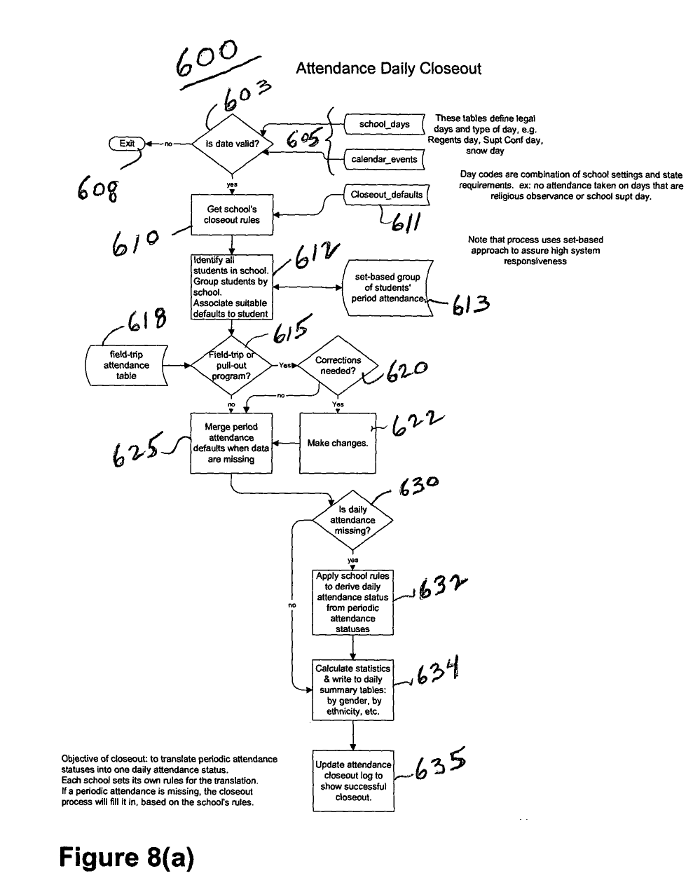

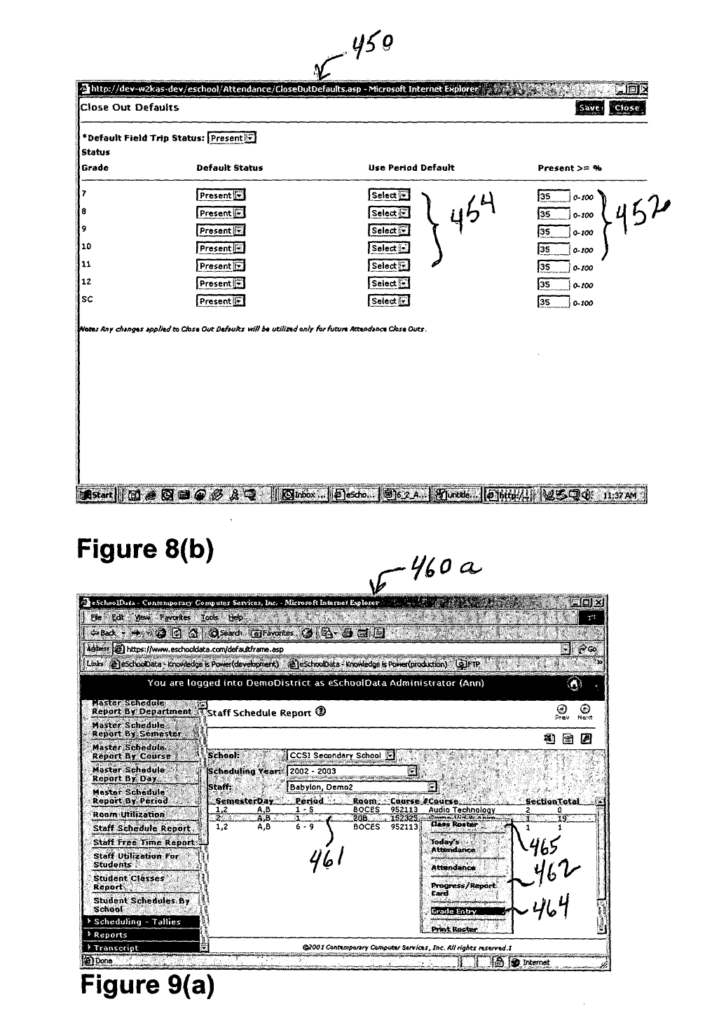

In accordance with the Attendance Management sub-system 51 (FIG. 1), the present invention implements a daily attendance closeout process thread that is performed district wide over the web to automatically derive whether the student is present for a day. By looking at the percentage of the student's day, a more accurate and correct determination regarding a student's attendance is made, and, as known, daily attendance is an important factor in determining state aid. FIG. 8(a) illustrates a flow diagram 600 of the daily closeout process that examines the periodic attendance records for each student for the day, and develops an overall daily attendance status for a student based upon the periodic attendance data and a variety of other criteria that can be specified by the district. The closeout will also fill in any missing periodic attendance information, such as for teachers who did not submit attendance records for some reason.

The closeout process occurs automatically based upon the parameters setup by an administrator via an attendance Closeout Defaults screen providing an entry window 450 such as shown in FIG. 8(b). In FIG. 8(b), an attendance clerk performing the closeout is able to choose certain options for the closeout process including options for determining how to translate a student's periodic attendance into a daily attendance status according to: 1) use of a daily percentage represented by entry boxes 452; or 2) use of a default period represented by entry boxes 454. These criteria are available at a grade level so that different options may be applied to each grade. If a Daily Percentage is used, a student will be considered present if the student is marked present for the requisite percentage of the periodic attendances for the classes where attendance is taken. For example, if the student is registered in 5 classes where attendance is taken, and the percentage chosen is 50%, a student will have to attend a minimum of 3 classes to be considered present for the day. An alternative way to establish the daily attendance status is to use a default period, as the baseline for all others. This applies mostly to situations in which there is a period that is considered a homeroom period and is designated as the one for taking attendance. Using this method of closing will take the periodic attendance record from the selected period, and apply that particular status (absent or present) to any other periods of missing information for that student. Moreover, each student's daily attendance record will reflect the attendance status of the chosen period. After entering the appropriate options, the eSD® system will apply the chosen option and prepare an attendance report.

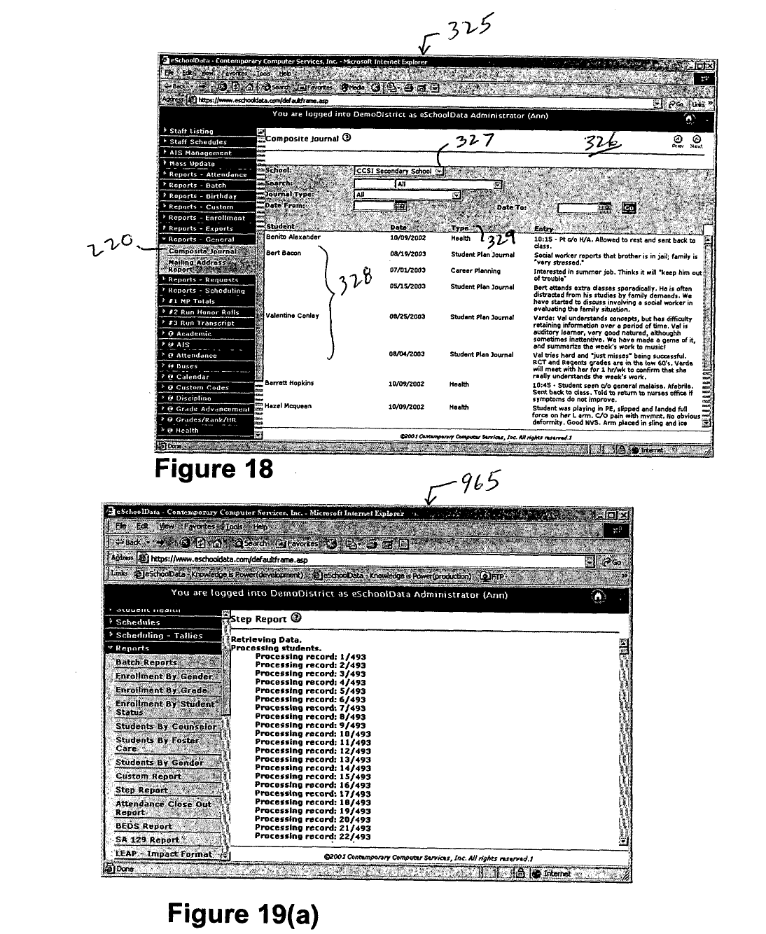

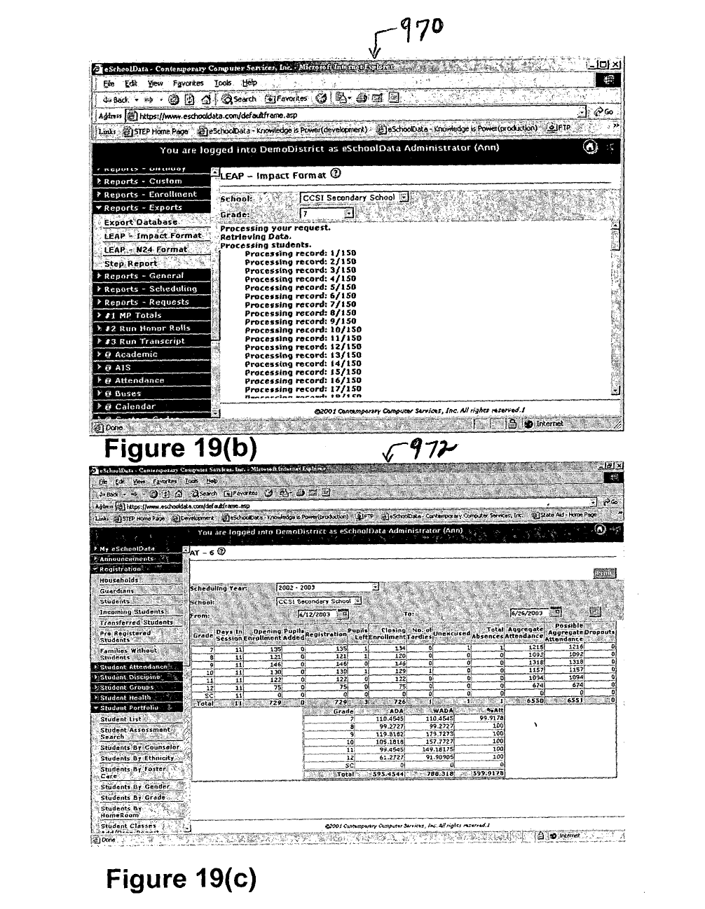

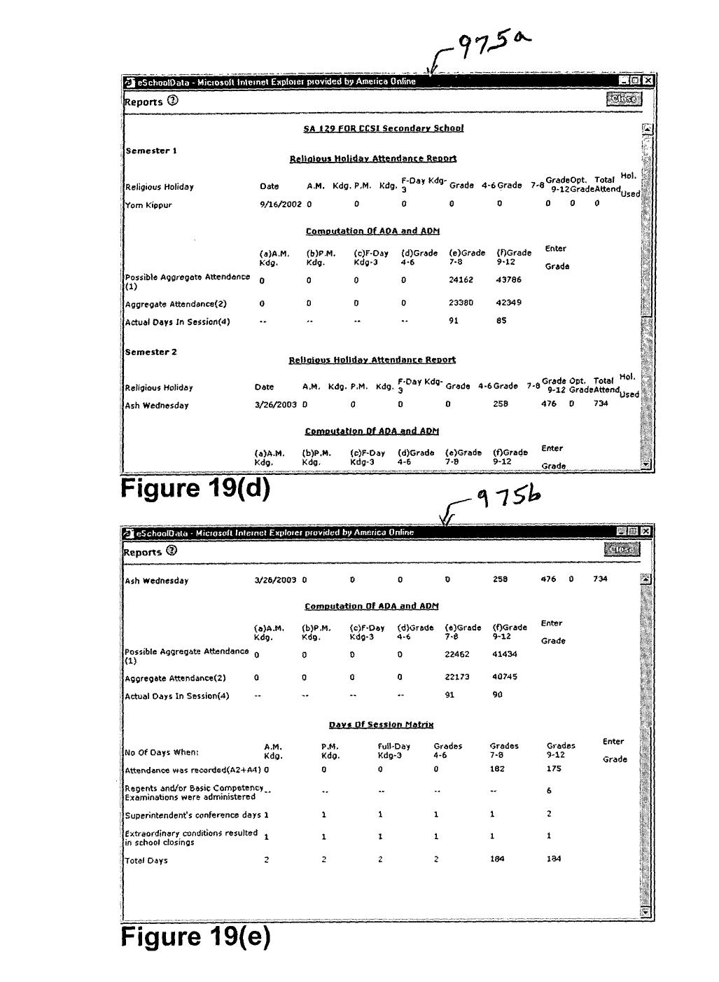

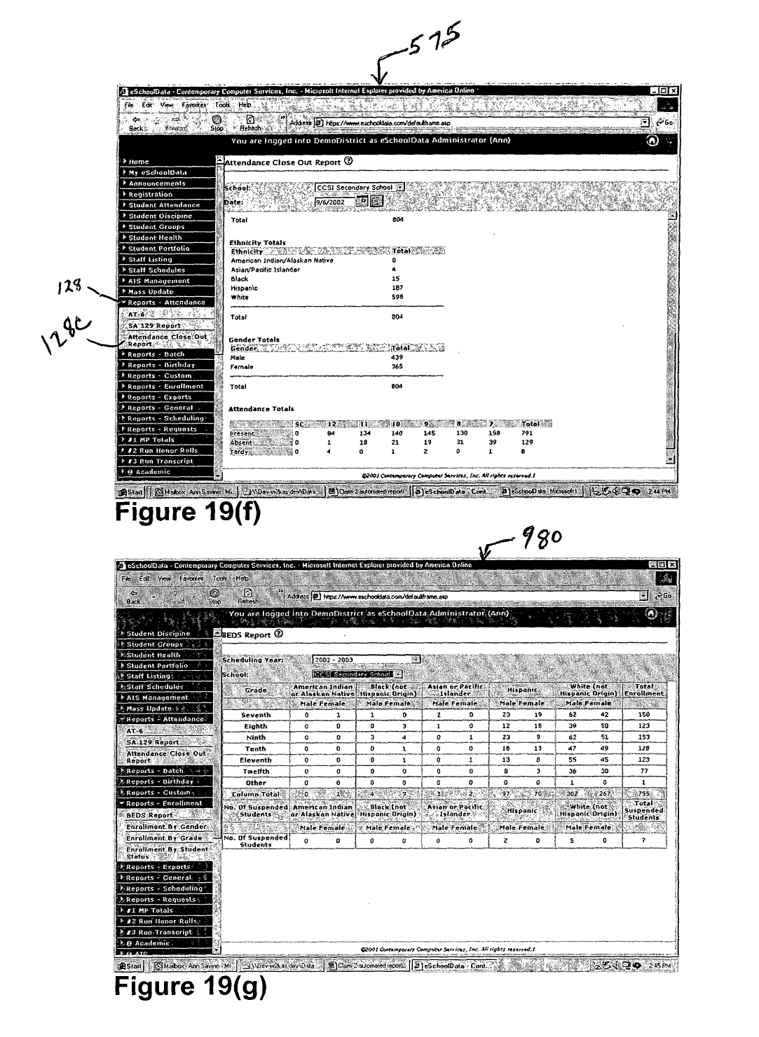

As shown in FIG. 8(a), the attendance daily closeout procedure 600 begins at a first step 603, where a determination is made as to whether the current data is a legal school day according to state law and according to district agreement. This information is derived from database tables 605 that define legal days and the type of day, e.g., Regents day, a snow day, etc. If the day is not valid, the system exits at step 608. If the day is valid, then at step 610 the system retrieves the school's close-out rules, such as discussed in connection with FIG. 8(b). Default closeout day codes 611 are defined that may comprise combination of school settings and state requirements. For example, a default may be that no attendance is taken on days that are religious observance or school superintendent day. Continuing to step 612, all students in a school in a particular district are identified and grouped by the school and suitable defaults are associated to the student. As shown at step 613, set-based logic is used so that each student is reviewed with appropriate status values for each period to ensure high system responsiveness. Next, at step 615, a determination is made as to whether the student was legitimately absent, e.g., present on a field trip or a pull-out program. Data concerning students field trip activity are provided from a field trip attendance table 618 stored in the database. After checking for field-trips and pull-out programs, then the process determines if any corrections are needed at step 620. If corrections are needed, the modifications in each student's values are made at step 622 and the process continues to step 625. Otherwise, if the student was not pulled out or on a field trip, or if no corrections were necessary, then at step 625, period attendance defaults are merged if data are missing. The eSD® system will never overwrite a period or daily attendance entered by a teacher or other human system user, as the system internally distinguishes between attendance status records entered by a person and attendance status records entered by the close-out process. Thus, continuing to step 630, a determination is made as to whether the daily attendance status has been established or not. If daily attendance is missing, then at step 632, the system will apply the school results to derive a daily attendance status from periodic attendance statuses. Next, whether or not daily attendance is missing, the process continues to step 634, where after all daily attendance statuses have been applied, statistics are calculated and written to daily summary tables organized by gender, ethnicity, etc. Finally, an attendance closeout log is updated to show a successful closeout at step 635. A Daily Attendance Closeout Report 575 generated in response to selection of a Reports-Attendance menu selection choice 128c for a single day is illustrated herein with respect to FIG. 19(f) and depicts an exemplary summary of all daily attendance statuses in daily summary tables organized by gender, ethnicity.

In educational systems, most forms of academic performance data are entered into a system by the student's teachers, and often take the form of grade entry or anecdotal comments. Comments can be freeform or selected from a specified list that depends on the course and the school. Other forms of academic performance data can be entered, scanned, or uploaded into the system by central office administrators or Regional Service Agencies. These performance indicators are usually in the form of Assessment data and may include assessment scores for State exams (Regents, RCTs, etc.). The eSD® system's integration and use of performance data enables objective assessment of the effectiveness of academic support programs.

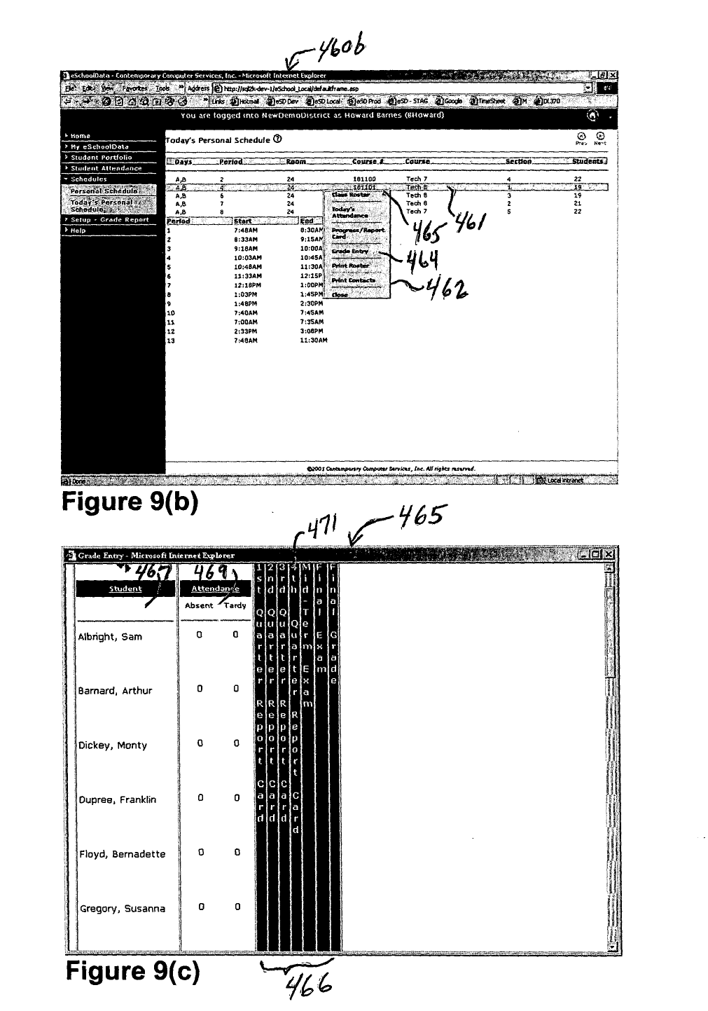

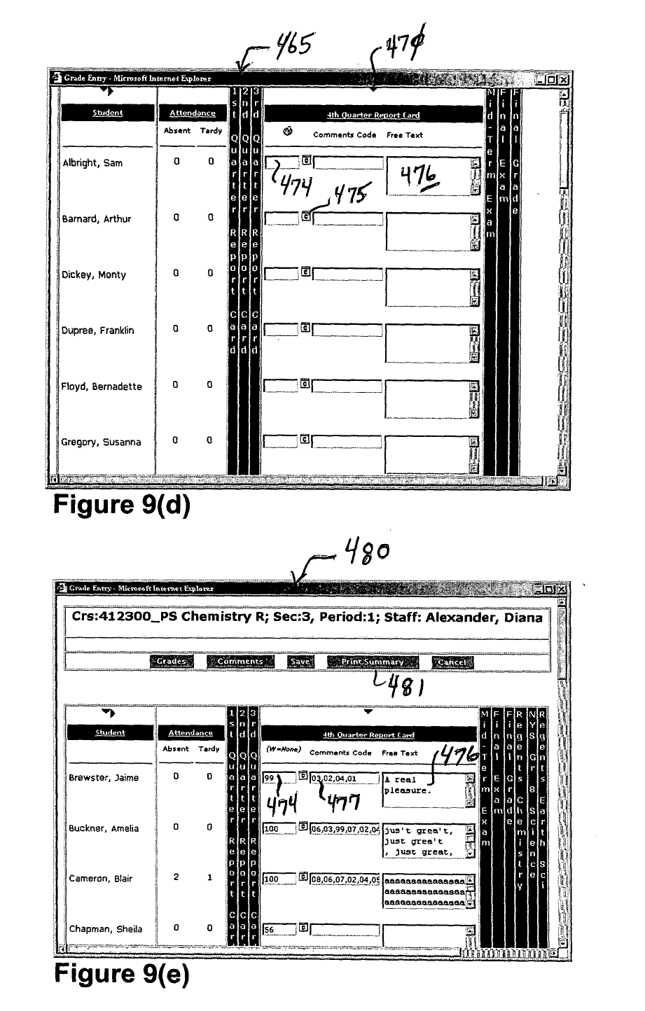

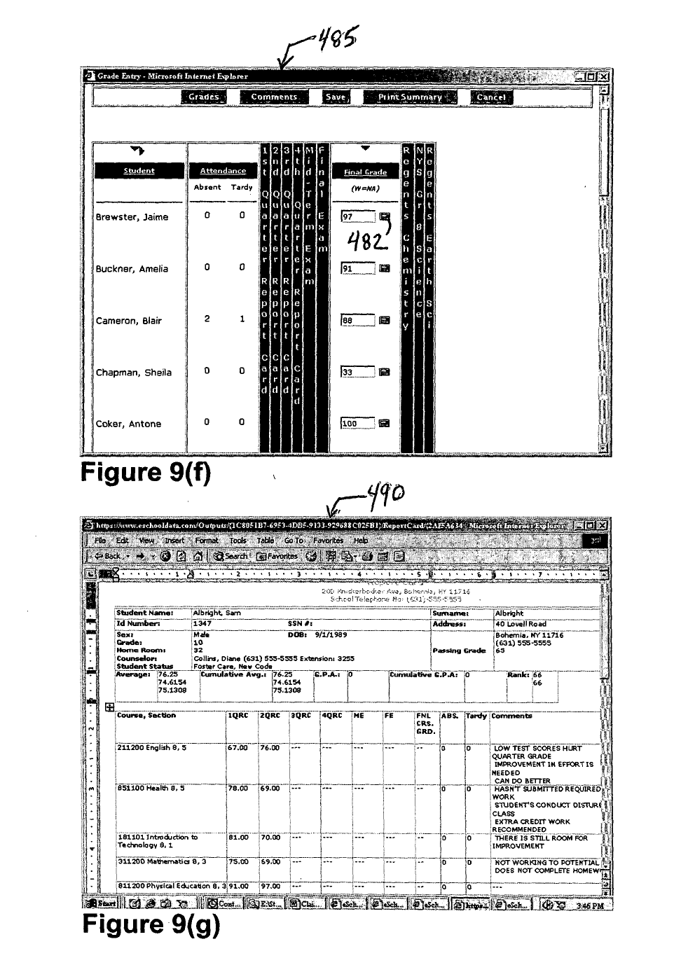

Preferably, according to the invention, class rosters for attendance, performance updates and grade entry may all be accessed through the same pop-up menu. Central Office administrators can further access staff schedules and class rosters by selecting staff names and specific courses from a staff schedule report, which may be accessed from the Schedules menu choice 125 of FIG. 2(a). An exemplary Staff Schedule Report interface is depicted as the example screen display 460a shown in FIG. 9(a). Teachers may additionally access their individual schedules and class rosters, or they can they can access this information from the “Today's Classes” interface from the Schedules menu choice 125 of FIG. 2(a). An exemplary Today's Classes interface is depicted as the example screen display 460b shown in FIG. 9(b). From each of the Personal Schedule or Staff Schedule Report interface displays 460a,b (FIGS. 9(a)-9(b)), a course 461 that a teacher or administrator desires to enter grades for is selected and a pop-up window 462 is presented with an option 464 for grade entry. Upon entry of grade entry option 464, a grade entry window screen 465 is presented as shown in FIG. 9(c) that supports the entry of periodic grade, a midterm exam, a final exam, a Regents exam, or any other assessment that has been assigned for the course. By clicking on a specific column 466, for a specific student 467 the user is enabled to enter grades, preformatted comments or freeform comments. Previously defined constraints for grades may be used to validate the data entered, so errors can be corrected immediately. Because it is an important factor in a student's achievement, the attendance (Absences and Tardies) record 469 for the student for the current marking period or quarter is derived from the system and displayed next to the student name. Thus, for example, in response to clicking on a 4^{th} quarter grade column 471, a 4^{th} quarter grade entry marking area 470 is generated such as shown in FIG. 9(d) which enables a teacher to enter either numeric or alpha grades obtained by the student in entry field 474, and/or may select one or more comment codes 477 representing particular comments a teacher wishes to assign to each student that have been made available for use in the district or the course by selection from a comment table drop down menu 475, or, enter free text comments in free text entry area 476. FIG. 9(e) depicts how the exemplary grade entry screen 480 appears after it has been completed.

The eSD® system has a feature to calculate the final grade for the student based on the grades in each marking period. The calculated final grade is a suggested grade, based on pre-defined course weights, and is offered as a tool, i.e., teachers have the ability to override the system's calculated final grade based on other influencing factors such as class participation or attendance. To invoke the grade calculator, the teacher selects a calculator button 482 to the right of the final grade, as shown in the exemplary screen display 485 of FIG. 9(f). In response to selection of the calculator, a suggested grade is displayed, and the teacher is given the option to accept the calculated grade or to cancel the suggested grade and enter another final grade instead. Even if the teacher does not accept the suggested grade, the tool provides the teacher with an idea of what a realistic grade would be for this student. Once the teacher has completed the entry of Grades, and/or Assessment scores via the grade entry interface, the teacher may look at the complete data that has been entered for that particular course by clicking on the Print Summary button 481 as shown in FIG. 9(e) which causes the presentation of a screen with all the data for that particular class and prints a summary. As further shown in FIG. 9(g), a report card 490 for a student generated via the grade entry portion of the system is depicted.

This grade entry functionality of the eSD® system is designed to automate the process of receiving and storing academic performance data so grade calculations can be performed quickly and in a way that minimizes the risk of making errors.

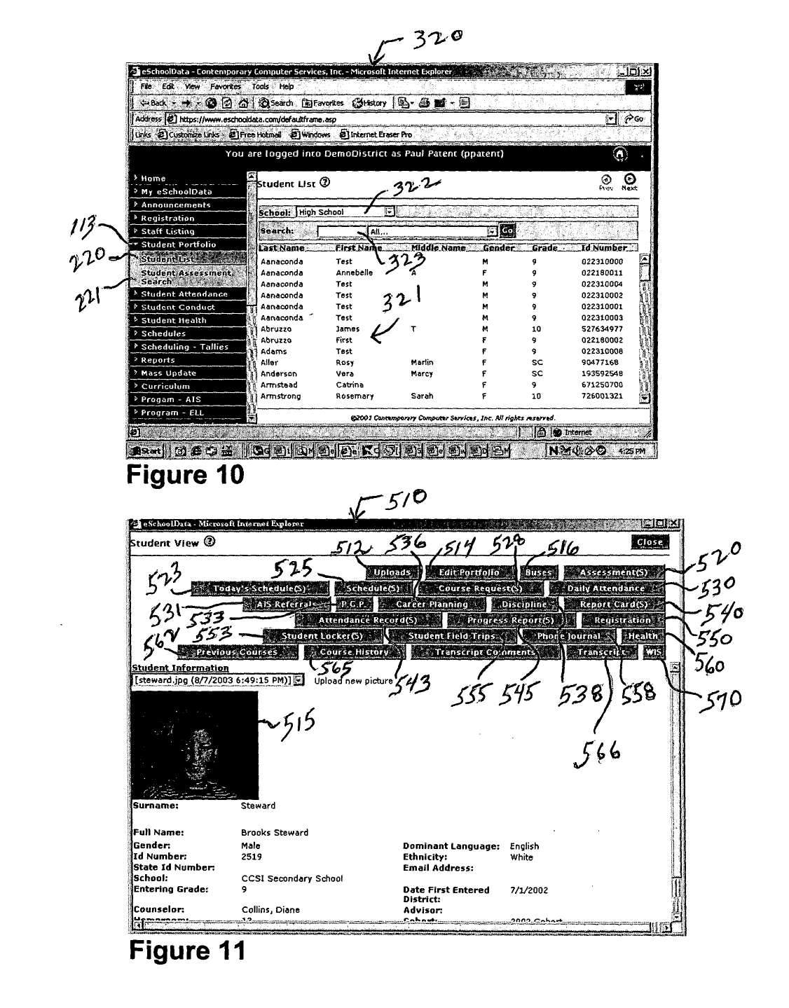

As described herein, student profile data are first captured when the student registers and attendance data are collected and maintained daily. According to the invention, the eSD® system provides a Student Portfolio Menu enabling a most efficient and comprehensive way for a school district to look at students, and particularly, to enable reviewing of student demographic data, attendance data and academic performance data. Referring back to FIG. 2(a), upon selection of the Student Portfolio entry choice 113, a Student List menu item choice 220 as shown in the exemplary screen display 320 of FIG. 10. Upon selection of Student List menu item choice 220, an alphabetized list 321 of all the students within a selectable school building 322 of the district is provided. When a particular name is selected via the list 321 or entered in the search field 323, the system generates for display a Student Portfolio View such as shown in the exemplary screen display 510 of FIG. 11. The Student Portfolio View screen 510 provides ready access to many system functions selectable by buttons including: an Uploads button 512 which when selected, implements functionality for enabling viewing of scanned data associated with the student, for example, an Individual Educational Plan (IEP), a scanned photo 515, or transcript from a prior school. Preferably, all uploads are available in one space and through one logical portal; an Edit Portfolio button 512 which when selected, implements functionality for changing the student's basic demographic information, such as an address; a Buses button 516 which when selected, implements functionality for adding or changing bus information associated with that student and which is automatically updated when a student is transferred from the building; an Assessments button 520 which when selected, implements functionality for evaluating the student's progress, as mandated by federal and state regulations. As will be described in greater detail herein, the eSD® system retains a multi-year assessment history and makes it readily available for use in evaluating the student's progress; a Today's Schedule(s) button 523 which when selected, implements functionality for enabling viewing of the student's schedule by period and the time that each period begins and ends; a Schedule(s) button 525 which when selected, implements functionality for enabling viewing of the student's schedules by semester; a Course Request(s) button 528 which when selected, implements functionality for reviewing or changing the courses that the student has requested, and which may be used for planning school schedules for the next semester; a Daily Attendance button 530 which when selected, implements functionality for displaying, adding or changing the attendance status for each day that school has been in session; an AIS (Academic Interventions Services) Referrals button 531 which when selected, implements functionality for program administrators to review the student's entire portfolio as well as composite journals which contain narrative information pertaining to all aspects of the student's academic experience and well being; a P.G.P. (Post-Graduate Plan) button 533 which when selected, implements functionality for displaying, adding or changing the post-graduate plans for a student, the categories of post-graduate plans having been prior established by a particular state and are used for state reporting; a Career Planning button 536 which when selected, implements functionality for displaying, adding or changing any anecdotal notes entered about student's career plans; a Discipline button 538 which when selected, implements functionality for displaying, adding or changing reports about disciplinary incidents which are categorized in the eSD® system using the federal and state codes; a Report Card(s) button 540 which when selected, implements functionality for displaying a students report card for the current or prior school year; an Attendance Record(s) button 543 which when selected, implements functionality for displaying a daily attendance status for the entire school year; a Progress Report(s) button 545 which when selected, implements functionality for displaying progress reports issued by individual teachers for this student; a Registration ) button 550 which when selected, implements functionality for providing access to the student's demographic data that were obtained at the time of registration; a Student Locker(s) button 553 which when selected, implements functionality for displaying, adding or changing student locker information which information is automatically updated when a student is transferred from the building; a Student Field Trips button 555 which when selected, implements functionality for displaying, adding or changing field trip information; a Phone Journal button 558 which when selected, implements functionality for displaying, adding or changing free-form notes related to phone conversations with the family; a Health button 560 which when selected, implements functionality for displaying, adding or changing health-related information including immunizations, medical conditions, physicals, results from hearing, vision and scoliosis tests, and miscellaneous information; a Previous Courses button 562 which when selected, implements functionality enabling viewing of information uploaded from another system or another school; a Course History button 565 which when selected, implements functionality enabling viewing of courses taken in prior semesters if the courses were administered by eSD® system; a Transcript button 566 which when selected, implements functionality for generating a transcript for only this student. It is possible to generate transcripts for a whole class of students using other menus from the eSD® system; and, a Walk-in-scheduling (WIS) button 570 which when selected, implements functionality for generating a full schedule or a new schedule for this student. The eSD® system further includes capability for generating and maintaining composite journals including narrative information pertaining to all aspects of the student's academic experience and well being, by enabling a staff member (teacher, administrator) to enter anecdotal comments about students. These comments are searchable by student or by journal type. Thus, referring back to FIG. 2(a), upon selection of the Reports menu choice 128a, a Composite Journal menu item choice 220 is provided in the exemplary screen display 325 of FIG. 18 which shows a composite journal 326 created for a selected school 327 that enables a user to view all entries of anecdotal information entered and concerning several students 328 in that school. For instance, as shown in FIG. 18, types of journals 329 that may be created for entry of anecdotal remarks concerning students include Career Planning, Discipline, Health, Phone Logs, Student post graduate plan, etc. As shown in the entry fields, comments may be added for AIS Student Plans, career planning, student health, etc. Having this information readily available assists counselors and decision-makers in making informed and educationally sound decisions.

In keeping with the eSD® system philosophy of integrated data, teachers are also able to access both attendance data and academic performance data for students on their rosters, such as available via the pop-up menu 462 that appears when they select an individual student from their rosters 465, as shown in FIG. 9(b) for example.

Referring back to FIG. 2(a), upon selection of the Student Portfolio entry choice 113, a Student Assessment Search menu item choice 221 is also provided in the exemplary screen display 320 of FIG. 10. Upon selection of the menu option 221, Student Assessment, there is provided a list of the students who have been tested on a standardized assessment test and a view of how an individual student's achievements compares with those of his/her cohort.

Effective educational programs require coordinated efforts among administrators, teachers, counselors and parents. The eSD® system facilitates this coordination by integrating various facets of the programs. To assure that program effectiveness is objectively measured, a district must first determine the program entry and exit criteria, the types of services that will be provided, and the frequency of those services. Examples of instructional support programs are: Academic Intervention Services (AIS), Enrichment Programs (EP), Gifted and Talented programs (G&T), English as a Second Language (ESL), English Language Learners (ELL), or Limited English Proficiency (LEP). For illustration purposes, an example of the AIS program is described, however it is understood that the system uses the identical logic to handle all types of instructional programs. Once policy decisions are made to define the program, there should be no deviation in language or interpretation. No exceptions should be made to the program entry and exit criteria unless an appropriate modification is made to school district policy.

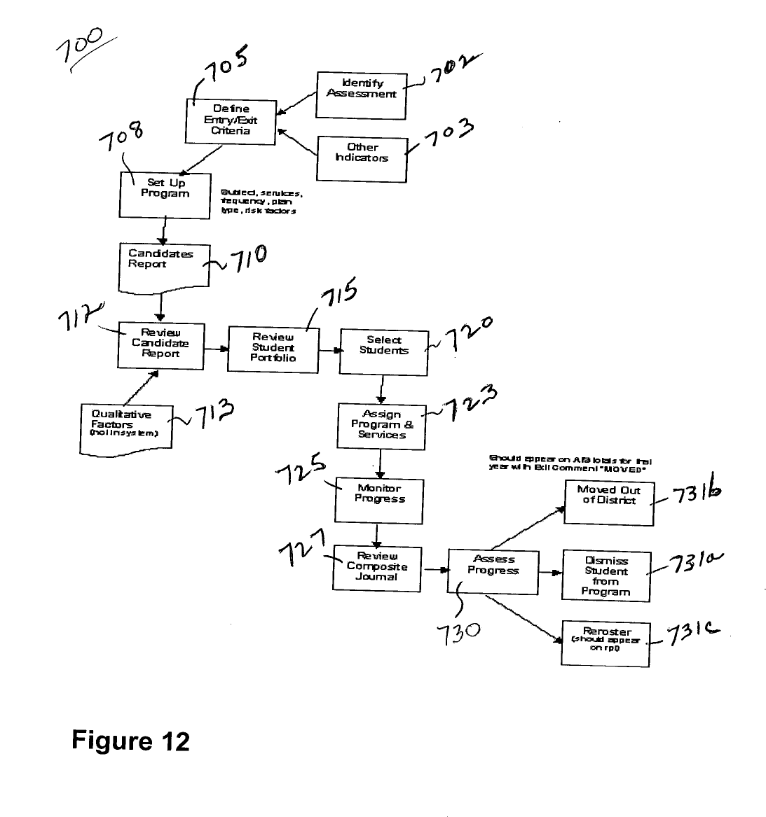

The eSD® system facilitates the program definition process 700 from beginning to end such as shown in FIG. 12 including the steps such as: identifying an assessment (local/state/federal) and other indicators 702, 703; defining the entry and exit criteria at step 705 with entry criteria including, for example, AIS Assessments/Measures, AIS Recommending Parties, AIS Frequencies, AIS Risk Factors and AIS Other Indicators; setting up the program at step 708 including the subject, services, frequency, plan type and any risk factors; generating a candidates report at step 710 and enabling the review of potential AIS student candidates at step 712 while taking into account qualitative factors 713, e.g., factors not in the system; review the individual candidate student's portfolio at step 715, which enables selection of the AIS recipient candidate at step 720; and, based on their individual assessments, the step 723 of assigning a program and services to the student; a further step of monitoring the progress of the student at step 725, and a step 727 of reviewing a composite journal for that student generated within the eSD® system indicating performance of the student receiving the benefit of the AIS service; and, a step 730 for assessing the progress of the student. As a result of the assessment, a student may be dismissed 731a from the program, or the student may be moved out of the district 731b in which case the student will appear on the AIS totals for that year with a status “Moved”, or the student may be re-rostered which would appear on the AIS report.

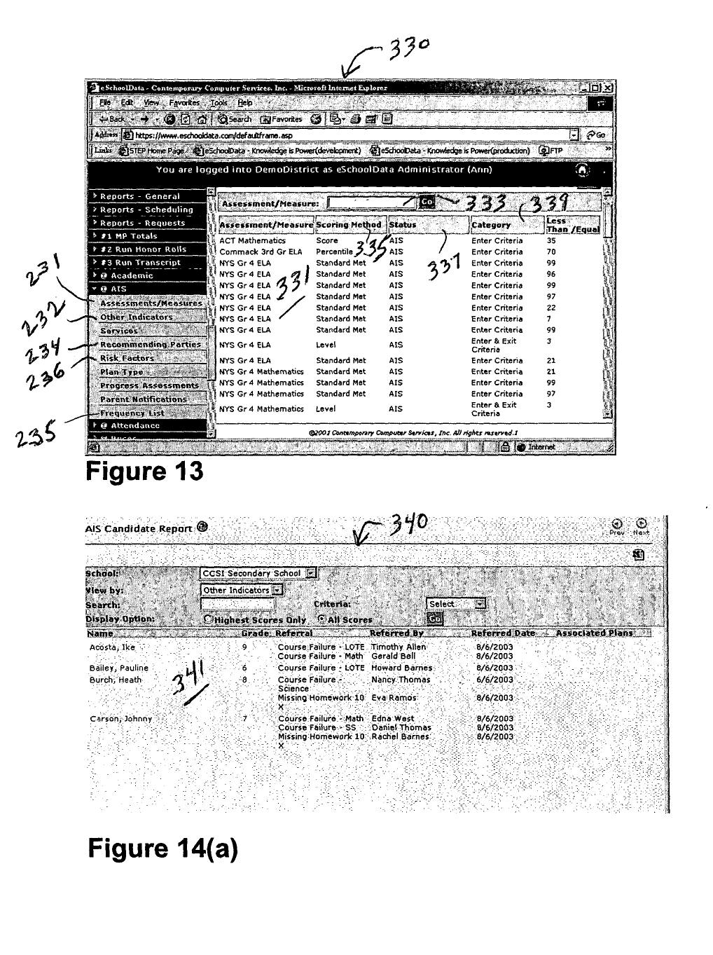

Referring back to FIG. 2(a), upon selection of the AIS menu entry choice 122, a Assessments/Measures Set-up menu item choice 231 is provided as shown in the exemplary screen display 330 of FIG. 13 which displays a list 331 of assessments and measures that are already available to the AIS program. AIS Assessments/Measures are those assessments and measures which have been marked as an assessment or measure usable for AIS programs. The system also supports a minimum criteria, allowing for an automatic calculation of a student's AIS eligibility. It is understood that the eSD® system is able to configure a new AIS assessment or measure (based on an existing assessment or measure already loaded in the system), for example, by selecting the menu item choice Setup-Programs 154 from FIG. 2(b) that generates an entry window (not shown) prompting for assessment/measure entry information. Referring back to FIG. 13, the assessment/measure criteria to be used as part of the AIS program includes the selection of an assessment or measure 333 that has already been entered into the eSD® system. Other selectable items include the type of scoring that will be used for this assessment or measure, a Minimum Grade 335 that will provide the criteria for entry or exit from an AIS program, and which number may be used to automatically select those students eligible for entry or exit from an AIS program, displayed in an AIS Candidate Report (described in greater detail later); a Status 337 to indicate to indicate this is an AIS assessment or measure; and, a Category 339 which may be selected to require that this score criteria will be used to determine AIS eligibility.

The AIS Other Indicators are any other indication (falling outside the realm of assessments and measures) that a district wishes to use to help flag a student for AIS status. For example, a general course failure (no specific associated assessment) would fall into this category. Referring back to FIG. 2(a), upon selection of the AIS menu entry choice 122, an Other Indicators set-up menu item choice 232 is provided as shown in FIG. 13 which displays other indicators that can be used to assist AIS administrators in easily identifying those students eligible for AIS. These could be any indicator, either specific or generalized, aside from the standard assessments that may indicate eligibility, such as class quiz scores, or a general course failure unassociated with a quantifiable assessment. The ability to set-up the other indicator is provided including any specific piece of information that should be attached to an indicator, such as a specific score on a class quiz. Note, a typical other indicator might be “General Course Failure”. A Status may be selected in the other indicator set-up that identifies the programs (e.g., ELL, AIS, or Enrichment) that can use this indicator, and a Category of the indicator identifies whether this indicator can be used as a criterion for entry, exit or both.

The AIS Recommending Parties comprise a list of people or groups that are permitted to recommend AIS for students. Referring back to FIG. 2(a), upon selection of the AIS menu entry choice 122, a Recommending Parties set-up menu item choice 234 is provided that enables administrative control of those permitted to recommend AIS programs for students. Districts are now able to coordinate and decide which administrators will be allowed to recommend AIS for students. The ability to set-up the Recommending Parties is provided in the eSD® system to constrain the list of recommending parties for AIS.

The AIS Frequencies comprise a list of the possible frequencies of occurrences of AIS Services. Examples include once per week, three times daily, etc. Upon selection of the AIS menu entry choice 122, AIS Frequencies set-up menu item choice 235 is provided that enables presentation of the current list of available frequencies.

The AIS Risk Factors comprise a list of non-quantifiable factors that may contribute to AIS decision making, usually logistical or sociological in nature; and upon selection of the AIS menu entry choice 122, AIS Risk Factors set-up menu item choice 236 is provided that enables presentation of the current list of available risk factors.

After an instructional support program has been defined via the set-up, school districts must determine which students are eligible for program services based on the school district policy. Students become candidates for AIS services when they have either scored below a “cut point” on an exam, or when they have been referred into the program based on “other indicators” which have been pre-defined in district policy. Traditionally, identifying students who are candidates for support services is an arduous task, primarily due to the following factors: 1) Student assessment scores may be delayed for several months, often arriving after the student has been advanced to another school building and has had a new ID number assigned; 2) Assessment results are often maintained in separate systems and cannot be easily correlated to students who are currently enrolled in the school district; and 3) schools do not have a means of consolidating quantitative assessment data and qualitative staff recommendations.

The eSD® system includes process threads to generate a candidate report that automatically selects students if the student scores below an established cut point on an exam or if the student has been referred into the AIS program by a staff member based on other predetermined indicators. Before determining whether a student will actually be enrolled into the AIS program, program administrators are able to review the student's entire portfolio as well as composite journals which contain narrative information pertaining to all aspects of the student's academic experience and well being.

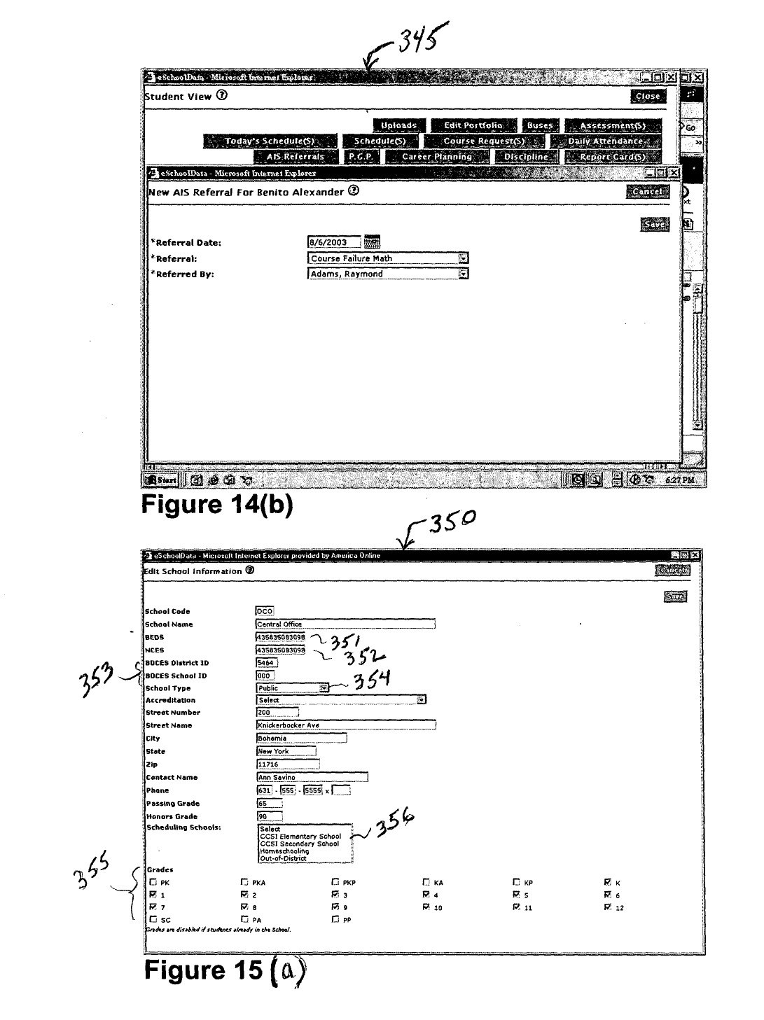

An exemplary candidate report 340 detailing a list 341 of students, along with the date and reason for their potential eligibility is shown in FIG. 14(a). Referring back to the Student View 510 in FIG. 11 of a selected student, selection of the AIS referrals button 531 menu choice for that student will reveal the recommendation as shown in the screen display 345 of FIG. 14(b).

Once defined, the effectiveness of a program is assessed by its impact on the students in the program. Positive impact is usually measured by improvement to assessment scores but traditionally, program administrators do not have a means of introducing “soft factors” into the monitoring process. Because the eSD® system embeds relevant journal entries/narratives into the system, program supervisors are able to take “soft factors” into account when monitoring student performance. Comments such as “Johnny has been working late nights to help support his family, he has not been eating and he frequently falls asleep in class.” provide powerful insight as to why Johnny's grades are suffering. When program administrators are dealing with several hundred student records, these soft factors that are known to the teaching staff often elude the program administrator. The situation of having insufficient information at the appropriate time may lead to recommendations for inappropriate interventions and/or overlooking simple solutions. For instance, if an administrator were to review Johnny's progress without consideration of the fact that he came to school hungry and sleep-deprived, the administrator may recommend additional academic support for Johnny. This decision would pull Johnny away from his regularly scheduled classes more frequently, and does not address the underlying issue. Similarly, the administrator might wrongly infer that Johnny's teacher is not providing an adequate learning environment, and conclude that the teacher is “weak”. Armed with the narrative, however, the program administrator can procedurally refer Johnny to a counselor to ensure that he receives nutritional and health guidance, or intervention by Social Services. Further details regarding the receipt and storage of journal entries will be described in greater detail herein.

A Schools Interoperability Framework (SIF) provides for the exchange of baseline data between school systems via XML communication standard, for example. However, the SIF initiative does not ensure compliance of the data being exchanged. Furthermore, SIF focuses on standard data elements as opposed to more complex, derived data. Typically, a data warehouse is used to consolidate data for longitudinal analysis. Since a data warehouse represents snapshots of flat data, statisticians are often discouraged by the limitations of the warehouse's “drill down” capabilities. Furthermore, since a data warehouse is not an operational system, users cannot “interact” with the data by creating triggers and alerts or by adding anecdotal records. In addition, the data warehouse model does not allow the program administrator to consider external contributing factors that might affect a program's effectiveness or an individual student's performance. According to the invention, the eSD® system provides the framework to force the appropriate field validation at the lowest level of detail, i.e., there are no limitations on the system's capability to derive data. In addition to providing a clean framework to enable compliant reporting, the system supports constant, progression and objective assessment of program effectiveness such as described herein with respect to FIGS. 12 and 13.

Thus, according to the invention, an integrated reporting system capable of conforming to the guidelines of each educational and/or governmental institution is provided that forces compliance at the lowest level of detail covering all reporting elements, thus surpassing the capabilities of a data warehouse model by providing reports that meet guidelines established by governmental authorities and using the same data to provide reports that meet the needs of local administrators, thereby promoting legal compliance as well as educational professionalism. Because the eSD® system ensures compliance by capturing clean data at the lowest level of detail, the eSD® system has the ability to derive data required for all aspects of government reporting. The following sets of data elements are uniquely controlled within eSD and force conformance with governmental mandates: 1) Institution Level Definitions; 2) Enrollment tracking over multiple years; 3) Attendance, enrollment and demographic composition of the school district; 4) Registration as described herein with respect to FIG. 3; 5) Student Program Participation over multiple years; 6) Poverty levels such as free and reduced lunch; 7) Funding Sources for Services; 8) Ethnicity categories; and 9) Post Graduate Plans.

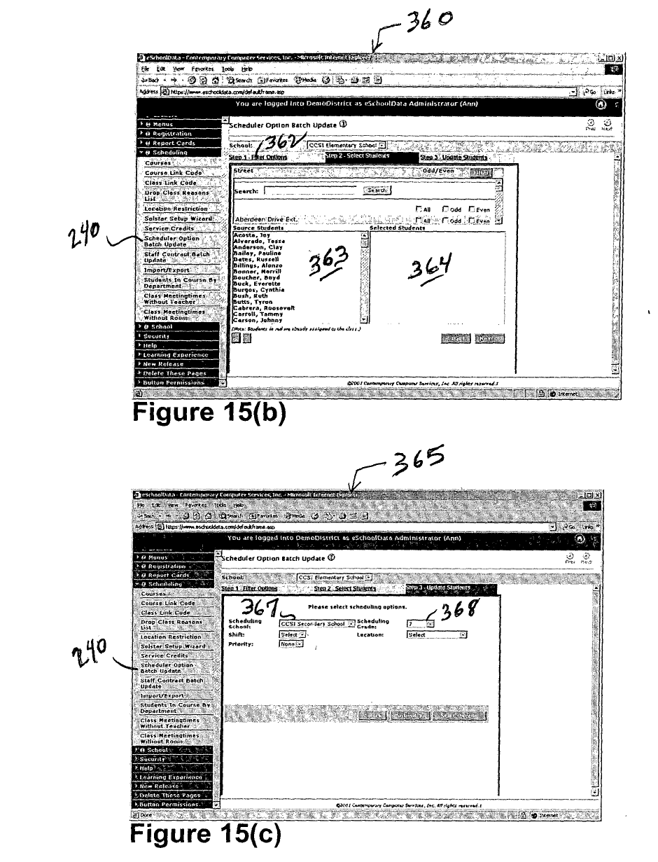

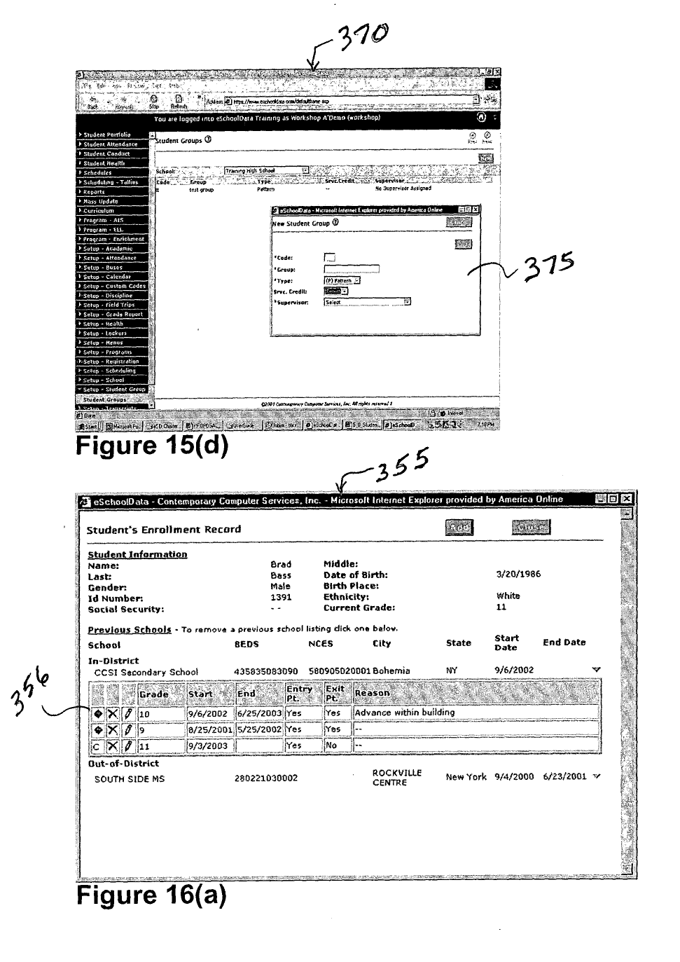

By selecting the menu item choice Setup-School 159 from FIG. 2(b) there is generated an entry window 350 such as shown in FIG. 15(a) prompting eSD® system functionality for enabling the set up of a school district in accordance with State and Federal reporting requirements, including for instance, the ability to enter information for a new school including: a school code, a school name, define a Basic Educational Data System (BEDS) code 351 for each school building; define a National Center of Educational Statistics (NCES) Code 352 for each building; define BOCES/Regional Center Ids 353; define a School Type 354 (Public, Private, Charter, Military, Religious, Religious, Non-District Public, Home School); define grade levels 355 taught in each building, and define Schools 356 that each building can feed into for scheduling purposes.

The eSD® system further enables the transfer of a student between buildings—including non-district schools, the maintenance of an enrollment record including, grade advancement, retentions, and transfers, and the maintenance of reasons for each transfer or change to the enrollment profile.

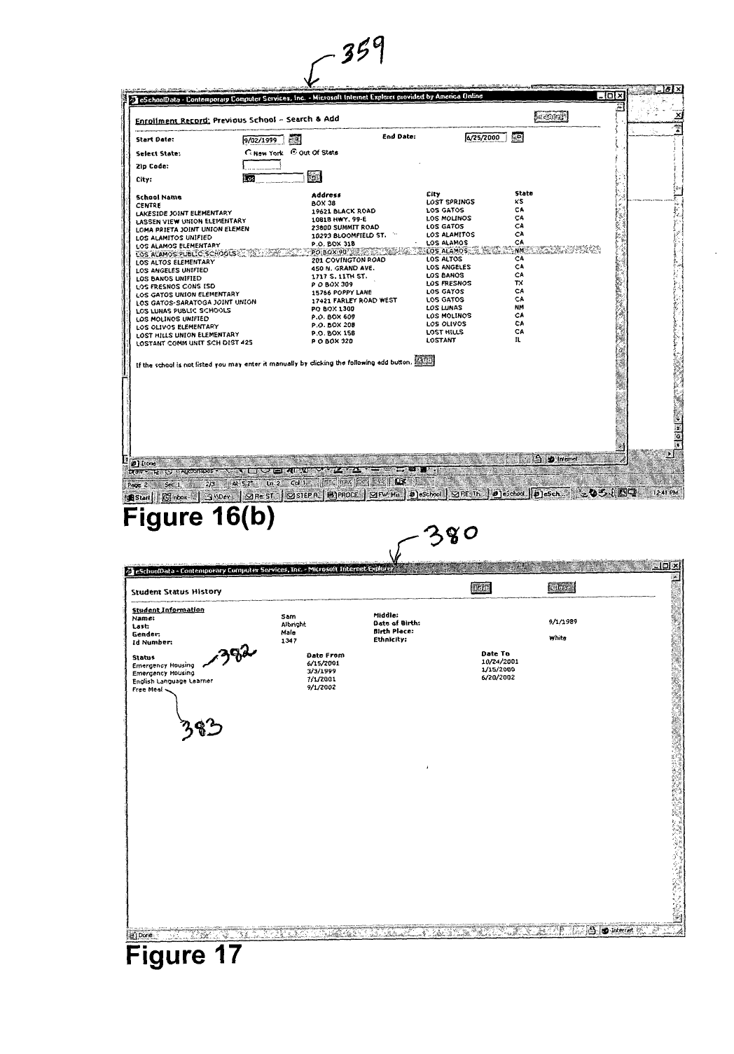

By selecting the menu item choice Enrollment-Summary 129 from main menu portal screen 100 of FIG. 2(a) there is initiated functionality enabling viewing of an enrollment record generated and maintained by the eSD® system for any student in the district. FIG. 16(a) illustrates an exemplary enrollment record 355 capable of being generated by the eSD® system. As shown in FIG. 16(a), the enrollment record 355 includes a display area 356 indicating transfers of the student between buildings—including non-district schools, grade advancement, retentions, and the maintenance of reasons for each transfer or change to the enrollment profile. The student's current school is always the last entry and is marked with a “C”, as shown in FIG. 16(a). The eSD® system enables the build of a Previous enrollment record which shows exactly which school district the student has attended in the past, or will be attending in the future, all selectable by date, as shown in an exemplary Previous School enrollment record 359 generated by the system as shown in FIG. 16(b). All school references, past, present and future use the appropriate NCES codes to facilitate accurate reporting to State and National agencies. Maintaining this level of detail on enrollment records 355 allows better monitoring of transient students, and it allows the receiving school districts to identify and hold “feeder schools” accountable for the academic success of students according to federal requirements. The enrollment record is accessible to all users from the student portfolio, thus classroom teachers are immediately aware of transience patterns and can provide individualized instruction accordingly.

Unique to the eSD® system is the maintenance of the student history and the generation of the enrollment record. At the time of grade advancement and/or transfer the eSD® provides functionality for automatically updating the student enrollment record. In accordance with this functionality, the enrollment record will automatically change every time a student record moves from school to school and/or from district to district. In connection with the generation of a student enrollment is the grade advancement process that is implemented for promoting students to the next-grade. The eSD® system provides many different scenarios to support the processes used in different school districts. At the end of the school year, for example, grade advancement for each student will follow one of three paths: moving up one grade, being retained at the current level, or graduation.

The steps in the process require the setting up of prerequisites such as the “scheduling” school. That is, for each school, the eSD® system enables administrators to indicate the new schools that will receive students from the current school; and, scheduling batch updates to associate students with their newly scheduled classes. The scheduled school is the school that will receive the promoted students or students who are retained in the same grade but are being transferred to a different building. From the exemplary School Information page depicted in FIG. 15(a), the scheduled schools may be designated by selecting from the scheduling schools list 356.

The eSD® system additionally enables the administrator to define the type of grade advancement for different groups of students. Four types of grade advancement are supported by the eSD® system including: advancement within the building; advancement to another building; retention within the building; and retention in another building. Depending on which option is selected, the system will perform different updates. A summary of the system updates for each type of advancement is shown in Table 1 hereinbelow. In addition to those listed, any update will remove all AIS services associated with the student and delete that student's locker and school bus assignments.

TABLE 1
UPDATES

| | | Transfer | Student | | | |
|---|---|---|---|---|---|---|
| Option | School Record | Table | Record | Locker | Requests | Buses |
| Advance | End current grade. | | Change | | | |
| within | Put end-date, | | grade | | | |
| building | reason, exit point. | | | | | |
| Advance to | End current grade. | Create | Change | Delete | Delete | Delete |
| another | End current | transfer | grade | | | |
| building | school. | entry | and | | | |
| | Put end-date, | | school. | | | |
| | reason, exit point. | | | | | |
| | Enter new school. | | | | | |
| | Add new grade. | | | | | |
| | Create entry- | | | | | |
| | point. | | | | | |
| Retain in | End current grade. | | | | | |
| building | End current | | | | | |
| | school. | | | | | |
| | Put end-date, | | | | | |
| | reason. | | | | | |
| | Enter new school. | | | | | |
| | Add new grade. | | | | | |
| Retain in | End current grade. | Create | | Delete | Delete | Delete |
| another | End current | transfer entry | | | | |
| building | school. | | | | | |
| | Put end-date, | | | | | |
| | reason. | | | | | |
| | Enter new school. | | | | | |
| | Add new grade. | | | | | |
| | Not an entry | | | | | |
| | point. | | | | | |
| Graduate | End current grade. | Create | | Delete | Delete | Delete |
| | End current | transfer | | | | |
| | school. | entry | | | | |
| | Put end-date, | | | | | |
| | reason. | | | | | |
| | Set exit point. | | | | | |
| Register Pre- | Register student. | | | | | |
| registered | Remove pre- | | | | | |
| students | registration flag. | | | | | |

To start scheduling the grade advancement, from the Scheduling main menu choice 124 of FIG. 2(a), the Scheduler Option Batch Update 240 sub-menu choice is selected which leads to generation of the exemplary screen display 360 depicted in FIG. 15(b). From the interface screen 360 of FIG. 15(b), the students may be selected using filter criteria 362 provided including grade, student status, group, program status, course or section. If multiple selection criteria are used, only students who satisfy all the criteria will be selected. In response to the selection criteria, a list of students 363 who satisfy the selection criteria will appear on the left window area as shown in FIG. 15(b). Via this interface, a user may select all names or any individual names for transfer to the window 364 at the right. After selecting the students, via a further screen 365 depicted in FIG. 15(c), the scheduling school 367 and scheduling class 368 may be selected.

Further eSD® system functionality includes the setting up of Student Groups menu item choice 160 of FIG. 2(b). Student groups are defined according but not limited to the following types: (P) Pattern—This group type is selected if students will be put into the groups based on a specific characteristic; (T) Team—This group type is selected to group together sports teams or other athletic groups; (C) Club—This group type is used to identify students participating in school sponsored clubs or groups; and (S) Service—This group type is specified when service credit is being given for student participation in the group—such as a Service Honor Society or EMT program. Upon selection of the Student Groups menu item choice 160 of FIG. 2(b), a screen display 370 such as shown in FIG. 15(d), is generated that enables the viewing of created groups and the creation of Student Groups. As shown in the pop-up screen display 375 of FIG. 15(d), the following information is provided in defined fields as shown for setting up a new group: a Group Code; a Group Name; a Group Type; Service Credits (if applicable); and a Group Supervisor. The eSD® system includes “mass update” functionality including functionality for providing a student group batch assignment that enables the assignment of students of a selected school in the school district to a group by tagging the students that should be assigned to the group.

As described herein, when students are transferred out of district, their academic services are ended and they are removed from the program. However, a record of the program participation is maintained. As students are grade advanced, they remain in the AIS program, but their services for the current school year are ended and similar services are created for the next year. FIG. 17 illustrates a STATUS HISTORY record 380 for a student that details the types of support services that the student has received and/or is currently receiving. In the FIG. 17, the exemplary student status record 380 indicates support services such as emergency housing 382, and free meals 383 was received in the past as indicated by the from/to dates.

As mentioned herein, a student's academic growth is measured by the administration of standardized assessment measures. In existing school data management systems, system administrators may define the course number, course credit(s), course weighting factors, maximum seating capacity, course subject area, course link codes, course prerequisites, course fees, and course scheduling parameters. However, in a typical system, there are only a set number of “buckets” that are used to store marking periods, e.g., midterm exam, final exam, Regents exam, and final course grades, etc. Each bucket is labeled by the system administrator, and weighting factors are then assigned to each bucket. These weighting factors are used to calculate a student's final course grade. Column headings on report cards and transcripts are static and the number of columns that can appear on the report card and/or transcript is limited to the number of buckets allocated by the system. The actual exam names and administration dates are not stored or displayed. As a result, student assessment scores are usually managed in an external system or spreadsheet and the process of reconciling data for reporting purposes is extremely tedious. Currently, data are not stored in a manner conducive to auto-generation of state reports.

In the eSD® system, local, state and national learning standards are deeply embedded into the following process threads identified in FIG. 1(b): Academic Program Management Process Thread 49; Attendance Management Process Thread 51; Course Enrollment Process Thread 43; Performance Assessment Management and Reporting 45; and, the Curriculum Management Process Thread 47. Particularly, all National/State Assessments are included within the eSD® system as well as the acceptable score types and score ranges for each assessment. System administrators may dynamically create local assessments and they have the opportunity to define acceptable score types for each local assessment. National, State and/or Local assessments can be easily tied to individual courses. Local assessments can also be associated with individual courses. There are no limitations to the number of assessments that can be associated with courses; therefore there are no “bucket” limitations. Furthermore, the grade entry interface as described herein is dynamically generated based on the number of marking periods and the number of assessments associated with each course. Weighting factors can be applied to all or some of the “buckets”.

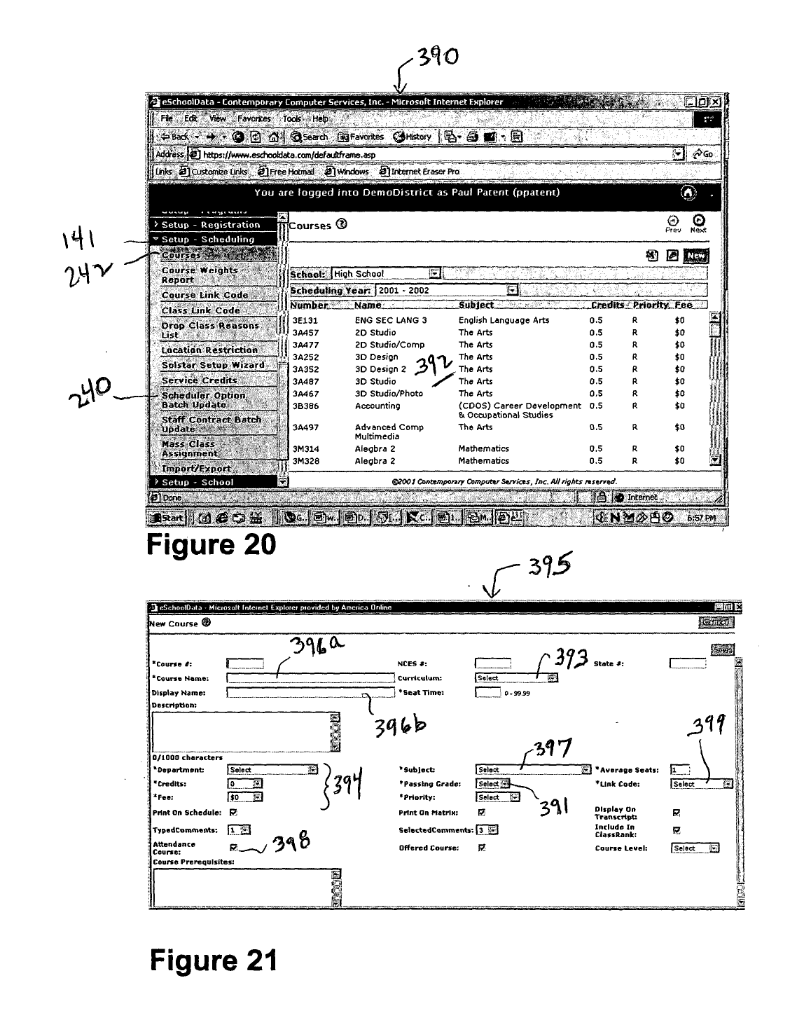

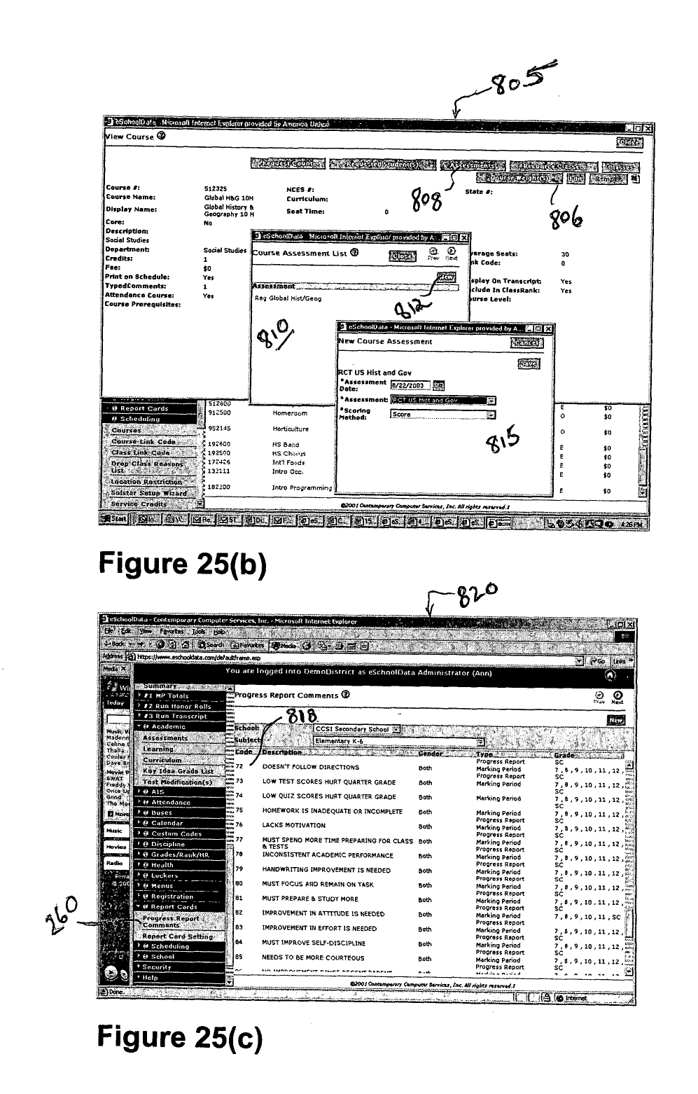

Referring back to FIG. 2(b), by selecting the menu item choice Setup-Scheduling 141 from eSD® system menu items of FIG. 2(b), and particularly sub-menu item choice 242, the Course Enrollment Process Thread 43 causes generation of an interface such as illustrated in the exemplary screen 390 shown in FIG. 20 that enables the presentation, selection, viewing and editing of all courses 392 offered in the particular selected school. By selecting the particular course, a screen (such as the exemplary “View Course” screen 805 shown in FIG. 25(b)) is displayed providing every detail about a selected course. Upon selection of a “New” button 393 from courses screen 390, a new course data entry screen 395 is provided such as shown in FIG. 21 that includes entry fields 396a, 396b enabling an administrator to define and enter both a Course Name as well as a Display Name. This allows for the more explicit naming of the course for PRC (Permanent Record Card) purpose, etc.; and another for the Transcript. For instance, a Course Name might be “Earth Science Modified” and the Display Name for the transcript would be “Earth Science.” There are further course detail entry fields 394 enabling entry of a Department, Credits, Fees and Subject 397 which may be selected from respective drop-down lists. Additional entry fields include selection of whether the course should be included as part of Rank Calculations, whether the new course is not a course in which attendance should ever be taken (Lunch, AIS, etc.) as entered in the “Attendance Course” checkbox 398; and fields indicating the number of Typed and Selected comments desired on Progress Reports and Report Cards. Additional entry fields include indication of whether the new course is going to be offered in this scheduling year, as selectable via the “Offered Course” checkbox, and, a selection for entering the default priority of this course (e.g., Alternate, Elective, Other, Required). An additional entry field includes selection of whether this course should link to another (such as a lab) in which case the user will select the link code from the “Link Code” menu field 399 and, whether this course is to be mapped to a curriculum, by choosing the curriculum tag from the drop-down menu field 393 labeled “Curriculum.” An additional entry field 391 includes selection of a “Passing Grade” from that field's drop-down list.

From the interface 395 provided in FIG. 21, the school district is further enabled to describe a course as being a special education course, e.g., without stigmatizing the student by displaying the special education designation on the child's transcript and/or report card. The Display Name 396b is used for transcripts and report cards, the Course Name 396a is displayed on a master schedule. Thus, instead of listing a generic header on an exam column of a student's report card, the exact exam name and administration dates appear on the student report card as shown in FIG. 9(g) and on the student transcript (if applicable).

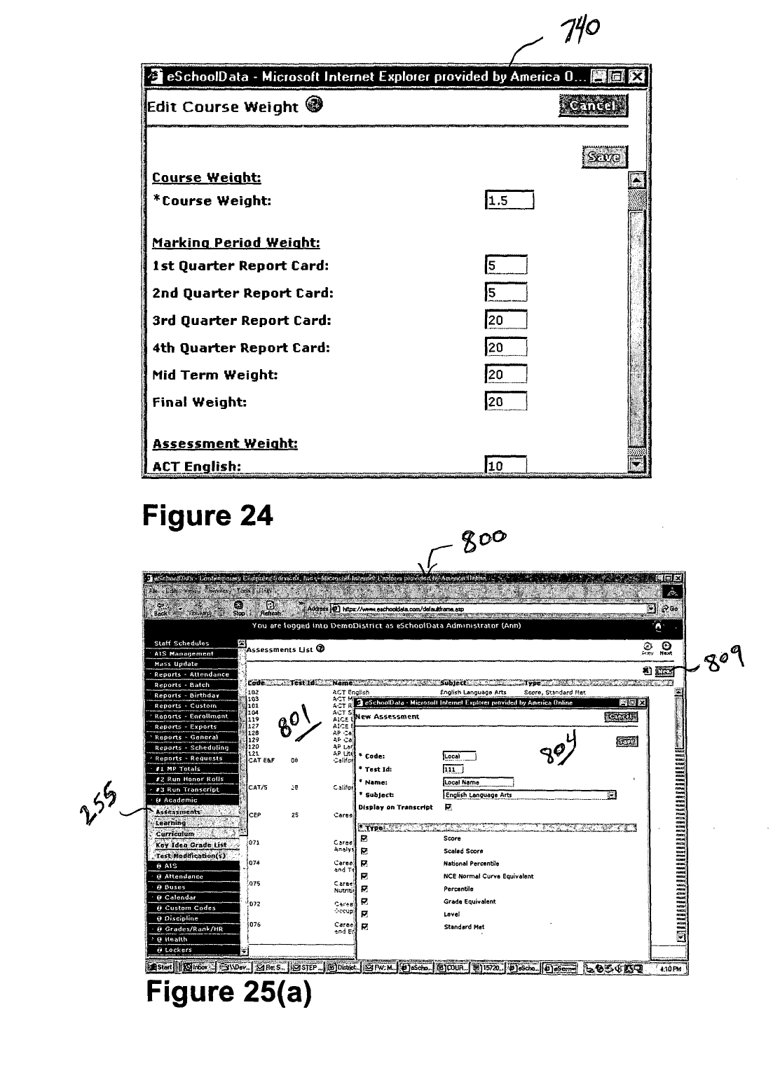

Via the eSD® system, actual Federal/State/Local Assessments may be associated to each course, including the ability to dynamically control the number of “buckets” available for weighting by adding additional assessments. Thus, referring to FIG. 25(b), after displaying a course details screen regarding a specific selected course, a user may select a Course Weights button 806 to configure how the course grades will be weighted. FIG. 24 illustrates an exemplary “Edit Course Weights” dialogue box 740 enabling entry of the correct weighting factors for the course and assessments per marking period.

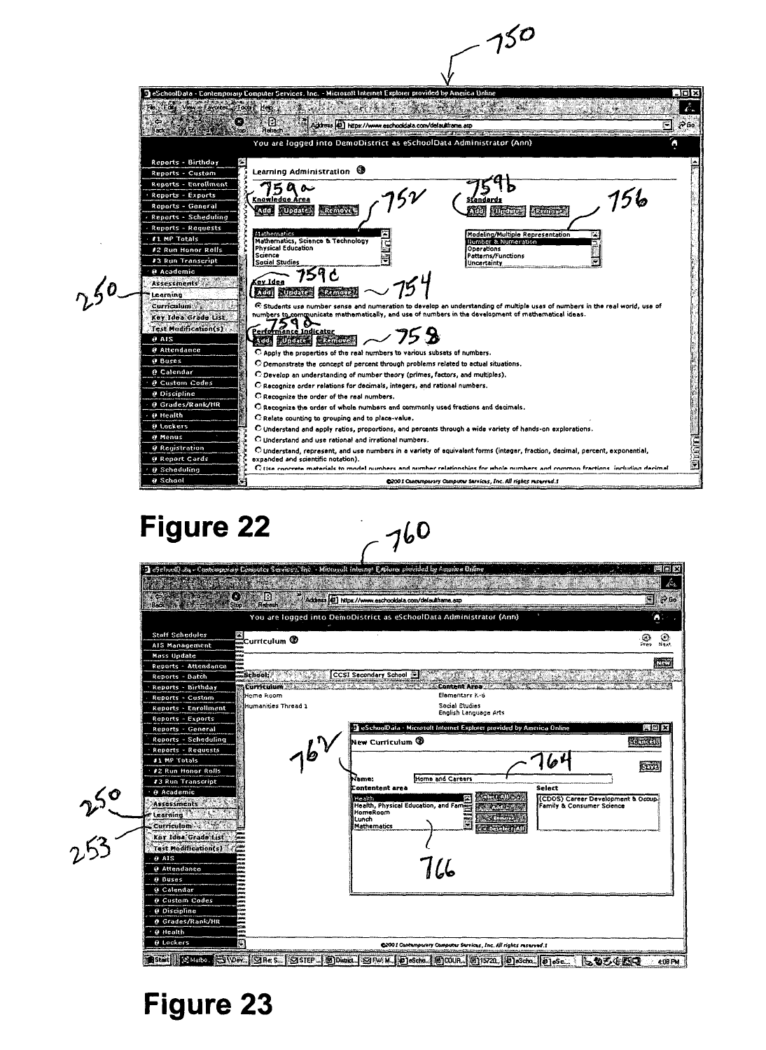

The eSD® system is further enabled to relate courses of study referred to herein as “Knowledge Areas” to the appropriate “Subject Area” as defined locally, or by State/Fed government. By selecting the menu item choice Setup-Academic 140 from eSD® system menu items of FIG. 2(b), and further selection of an Academic Learning sub-menu choice 250, there is caused generation of a Learning Administration interface such as illustrated in the exemplary screen 750 shown in FIG. 22 that enables the presentation, selection, editing and modification of a Knowledge Areas 752 and the corresponding association with an Academic Standard 756, whether State/Federal or locally mandated. That is, all Knowledge Areas (alternately referred to herein as Subject Area, or Content Areas) are loaded for individual states with each Knowledge Area being related to one or more Standards. Upon selecting a Knowledge Area 752, the corresponding standards are displayed and upon selecting a standard, all corresponding key ideas 754 related to that standard are displayed. Upon selecting a key idea 754, corresponding performance indicators (benchmarks) 758 are displayed to help the educators focus on what they are supposed to be doing. It is understood that, at any point in time, “Add” buttons 759a-759d may be selected to enable either creation at the very top level a brand new knowledge area, a completely different subject area where a new hierarchy may be built and which the backend processes of the system defines as locally developed. Thus, users may edit/remove/change the local knowledge area/standards, etc. building upon the state standards at any portion, including adding, at any point, the associated standards, a performance indicator, or, at any time they can build on a performance indicator, or new key ideas such as shown in the exemplary learning administration interface shown in FIG. 22. School districts thus are provided with the ability to measure, if they think it is important, other performance and they could extract the performance on a local scale with no bearing on the state/federal mandate. Even with the ability to add, remove and edit local standards, it is understood however, that the backend process threads of the eSD® system lock down all State and Federal standards to ensure that no changes may be made to Federal and or State Knowledge Areas, Standards, Key Ideas, and Performance Indicators. If a school district decides to define local Knowledge Areas, Standards, Key Ideas, and Performance Indicators, they must first determine whether their local standards are indeed different from State and/or Federal. Thus, the process forces a school district to align its academic objectives to state and/or federal objectives.

In the eSD® system, school districts are forced to make academic decisions for every course being offered before a student can be scheduled into a class or time block. This means that for every block of time in the day, administrators and teachers know what the learning objectives are for this time period. Teachers are further assessed based on a students academic growth in their classroom. Districts have the means to measure adequate yearly progress which heretofore has never been taken to ensure academic accountability at the classroom and district levels. Further, by aligning academic standards to every single course offering and being able to tie those standards to well crafted, academically focused report cards and progress reports are an extremely valuable academic measurement tool. Since these tools are crafted locally (yet forced to be aligned to state and federal learning standards through the use of the eSD® system) districts have the ability to assess students at an individual basis without changing their existing process or adding additional expense for testing tools. Further, by storing all state academic standards and performance indicators, the eSD® system ties in federal academic standards and performance indicators (benchmarks) while allowing school districts to add local academic standards while forcing alignment of local academic standards. The system allows schools to synthesize, combine and apply federal/state/local learning standards to individual course objectives thus eliminating redundancy or “fuzzy” academic objectives—or deviations to conform to nationally normed tests. The eSD® system thus recognizes that the only means teachers have to evaluate students at an individual level is through interim reports and report cards. By transforming the traditional interim reports and report cards into true academic assessment tools—school districts have the ability to synthesize the feedback of their teaching professionals.

The eSD® system further enables school districts to relate each course to a pure subject area, or they can make correlations between subject areas by creating Curriculum Strands. A curriculum strand can then be associated with a particular course. This approach (associating curriculum strands to the course) is extremely unique because it gives school districts the opportunity to embed local learning objectives and performance indicators into the course objectives. Traditionally, standards-based report cards are only aligned to state standards. Using this approach, standards-based report cards and progress reports are aligned to state and local course objectives—thus school districts can define course objectives. By selecting the menu item choice Setup-Academic 140 from eSD® system menu items of FIG. 2(b), and further selection of a Curriculum sub-menu choice 253, there is caused generation of an interface such as illustrated in the exemplary screen 760 shown in FIG. 23 that enables the presentation, selection, editing and generation of a new curriculum, for instance as shown in the pop-up data entry screen 762 shown in FIG. 23 enabling the entry of a new Curriculum 764 and the specification of one or more different content areas 766 making up the curriculum via data add/select/remove selectors. Thus, for example, many knowledge areas or content subject areas may be pulled together, for instance in the creation of a curriculum, e.g., a newly defined humanities curriculum may be defined to include English language arts, social studies and the arts.

The eSD® system is further enabled to dynamically control a teacher's grade entry interface to include an actual Assessment. That is, districts can associate any Federal or State exam to a course. Thus, by selecting the menu item choice Setup-Academic 140 from eSD® system menu items of FIG. 2(b), and further selection of an Academic Assessment sub-menu choice 255, there is caused generation of an interface such as illustrated in the exemplary screen 800 shown in FIG. 25(a) that displays a list 801 of assessments including the assessment code, name, subject and type, e.g., for associating Federal or State exams to a course. Upon selection of a “New” button 809, a dialogue entry screen 804 enabling the input to the eSD® system of a new assessment is displayed including entry fields for specifying a code, test ID, the local name, or subject, the type of assessment and whether it is to be displayed on the student's transcript. Districts may additionally define local Assessments and scoring methods for particular courses offered in their district. Thus, from the view course screen 805 of FIG. 25(b), a user may select the Assessments button 808 where the course assessment pop-up display 810 is generated that lists current assessment for that course. Assessment measures may be assigned for each course. Upon selection of the “New” button 812 from pop-up display 810, a user is enabled to enter a new Assessment via display interface 815 shown in FIG. 25(b), including entry of an assessment date and a scoring method. After an assessment measure has been assigned, the assessment measure will automatically appear on the grade entry screen such as the exemplary “Grade Entry” screen 480 depicted of FIG. 9(e). As specifically, the exemplary “Grade Entry” screen 480 depicted of FIG. 9(e) depicts how the eSD® system generates an association, for example, a state's Regents Chemistry, NYS Gr. 8 Science, Regents Earth Science assessment exams with the Chemistry course and enables a teacher's grade entry screen to automatically reflect inclusion of the assessment as depicted in FIG. 9(e). The assessments may further be included in the calculation of a weighted final grade.

Thus, in the eSD® system, students' reports cards are generated based on academic standards—not just alpha numeric grades and comments. Report cards and student transcripts are generated dynamically including the actual assessment name and date of administration. Grades are validated at the point of entry, and, as mentioned herein, a teacher cannot enter a score that is out of an acceptable range, e.g., a Pass Fail can only be entered when the State and Federal government permit P/F, percentiles cannot be entered when scaled. Thus, each report card and progress report becomes a valuable tool for academic assessment—not a disjointed reporting function. Further, by synthesizing progress reports and report card data, districts will be able to assess student academic performance based on teacher assessment.

Academic growth is monitored by guidance counselors and other school support personnel as part of the educational mission of the institution. In addition, students at risk can be identified by reviewing several reports capable of being generated by the eSD® system that identify unusual situations, including the following: Candidates Report used to identify students who qualify for academic intervention services as described herein with respect to FIG. 14(a); Students with Excessive Absences, based on daily attendance status; Students with Excessive Class Absences to identify students who consistently miss one or more classes; and, Progress reports which seek to engage parents and guardians in fostering a positive educational environment. Progress Reports generated by the present invention particularly allow for free-form comments or comments from a predefined list to be entered. For example, by selecting progress reports comments menu item choice 260 of FIG. 25(c), a screen display 820 is generated comprising a list 818 that describes progress report comments and associated codes that may be added to the student's report card via the grade entry screen entry fields 474, 475 of FIGS. 9(d)-9(e). It should be understood that the available comments list 818 shown in FIG. 25(c) address attendance, class participation and activities as well as academic achievement. Each school may customize the comment selection to align with their specific educational goals.

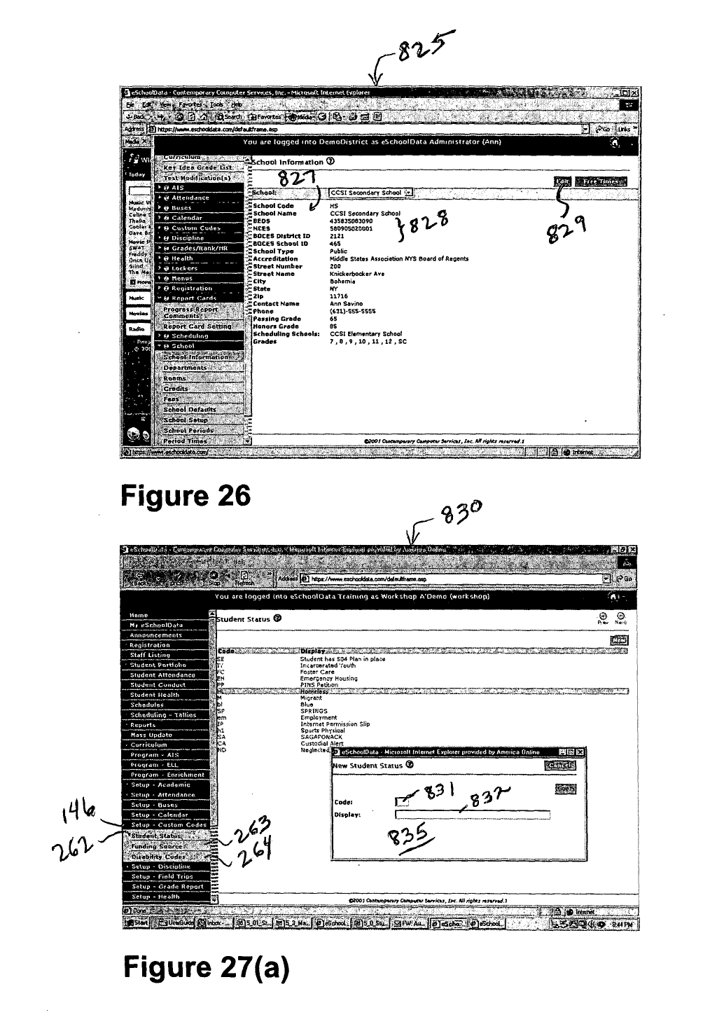

Codes that identify the district and the school are established when the school district is set up. Referring back to FIG. 2(b), by selecting the menu item choice Setup-School 159 from eSD® system menu items of FIG. 2(b), there is generated an interface such as illustrated in the exemplary screen 825 shown in FIG. 26 that enables the presentation, selection, viewing and editing of all information 827 pertaining to the school, including the relevant codes 828. Selection of an “Edit” button 829 will enable an authorized user to edit the selected school information. The eSD® system downloads codes from the government sites and incorporates them into the software template such as shown in FIG. 1(a). They are a keystone in maintaining data integrity and assuring compliance with government reporting. Ethnicity, gender, guardian relationship, and other categories defined by the codes and required for state reporting are presented as drop-down lists, restricting input to acceptable selections.

The eSD® system provides functionality enabling the creation and management of custom codes associated with a particular group of students having a similar demographic or characteristic. The system further enables tracking of custom codes such that performance reports may automatically indicate custom codes suitable for the use by the local educational institution level. There are three types of custom codes that are used in the eSD system: 1) Student status codes which are codes to identify students based on certain characteristics or attributes of the student; 2) Funding source codes, e.g., Federal funding codes, which are codes assigned to students who receive grant dollars, and may comprises local codes added by a school district; and, 3) Disability codes which are Federally defined codes that are used for STEP and LEAP reporting. It is understood that each school district may add local codes. The eSD® system maintains the codes that are used for state and federal reporting. Any funding codes and disability codes created by individual school districts are not used in standard reporting.

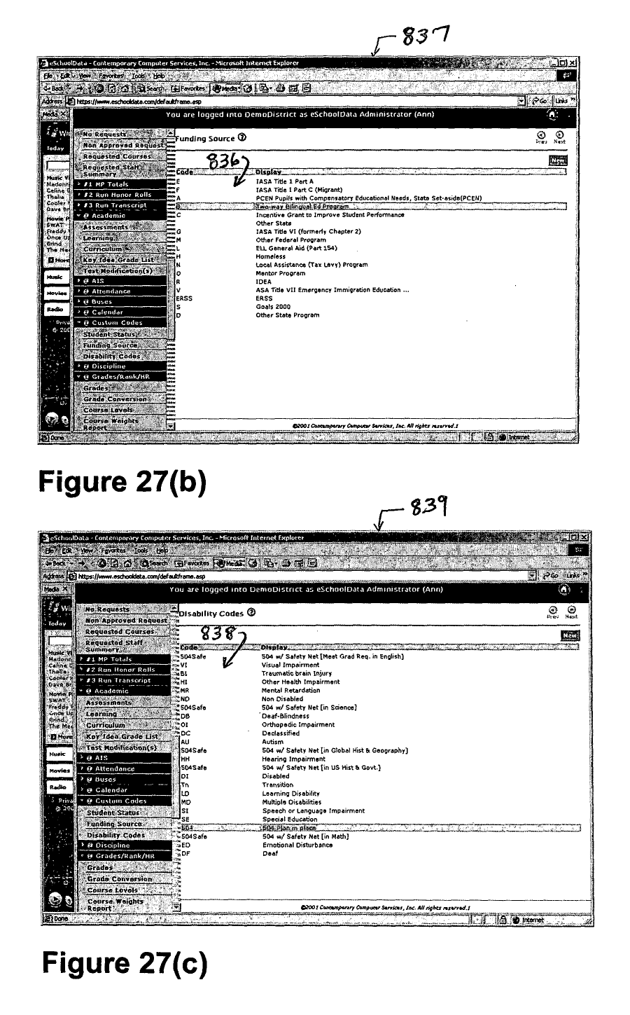

Referring back to main menu screen of FIG. 2(a), selecting the menu item choice Custom Codes 131 from eSD® system menu items display 100 causes generation of an interface that enables the presentation, viewing and editing of all information pertaining to the school custom codes, including the relevant codes 827 (FIG. 26) in various school districts. It is understood that selecting the Setup-Custom Codes Menu choice 146 of the main menu screen 100 in FIG. 2(b), a Student Status screen such as the exemplary screen 830 shown in FIG. 27(a) is generated by selecting the student status menu item 262. From this screen, a user will be able to click “New” and which generates a pop-up dialog box 835 enabling the user to define: 1) a Status Code 831; and, 2) a Status Name 832. When creating codes that should be categorized as disability/special education codes—the user selects from Disability Codes 263 or Funding Source 264 from the sub-menu item choices for Set-up Custom codes. The exemplary screen 837 shown in FIG. 27(b) illustrates the use and maintenance of Funding Codes 836 that are already in use in various school districts and, the exemplary screen 839 shown in FIG. 27(c) illustrates the use and maintenance of Disability Codes 838 that are already in use in various school districts.

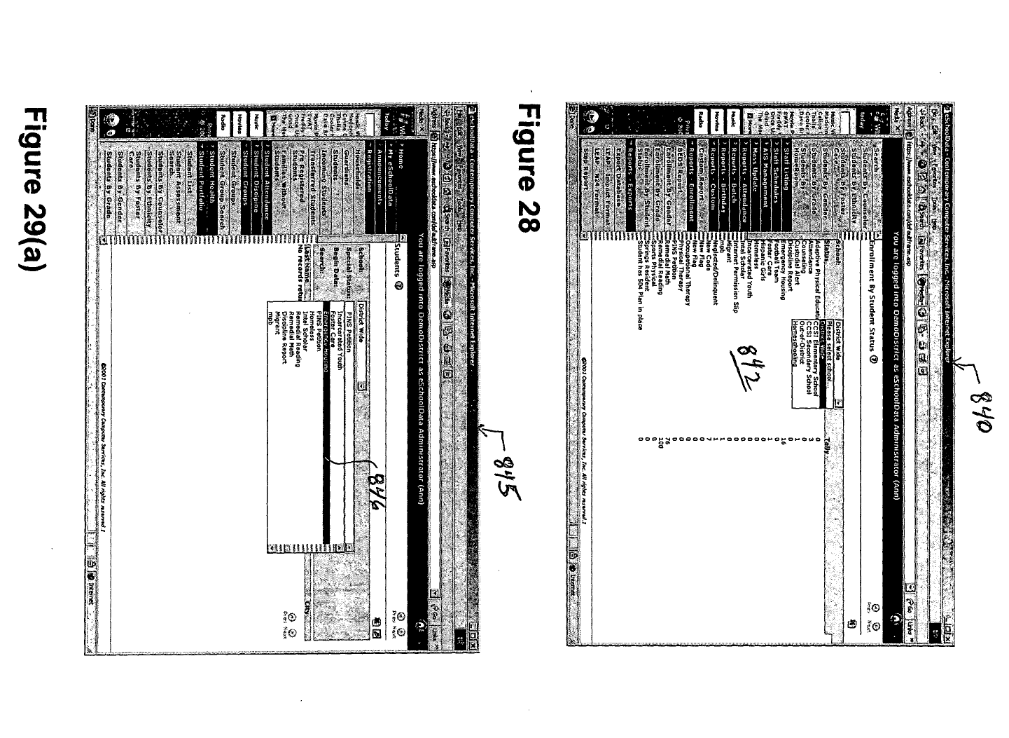

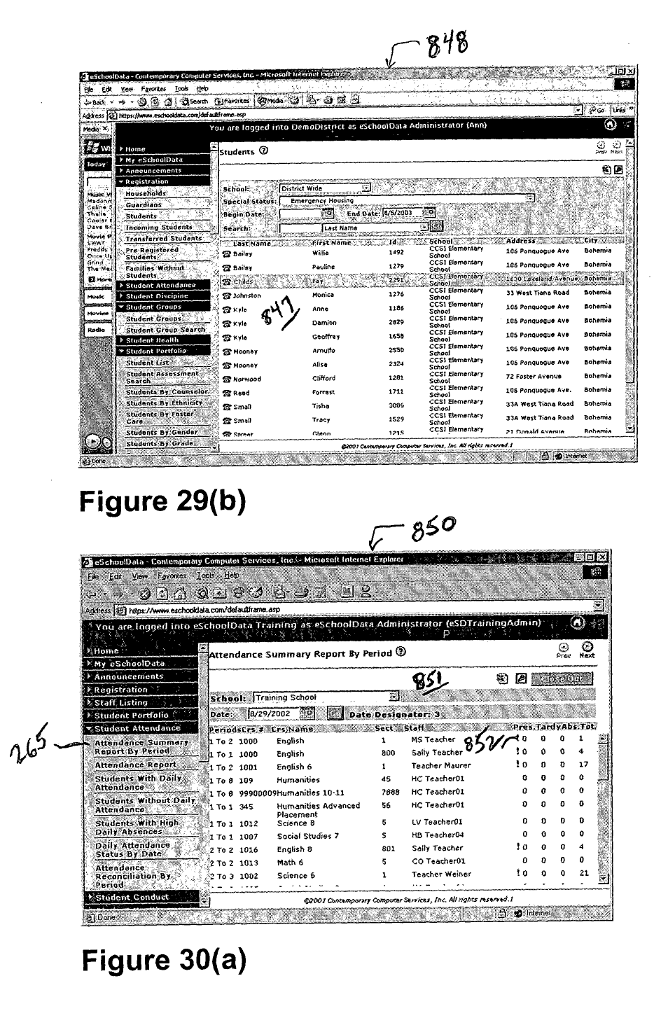

According to the invention, the codes depicted in FIGS. 27(a)-27(c) are used for aggregate reporting and also for customized reporting. Aggregate reporting is available by district or by a school building, as shown in the exemplary screen display 840 of FIG. 28 which depicts the generation of an Enrollment report 842, for an example school, showing the tally of students on the basis of their status as represented by student codes. Thus, functionality is provided that enables students to be monitored according to their special codes. For example, by selecting the menu item choice Registration Student 110 from eSD® system menu interface 100 causes generation of an interface such as illustrated in the exemplary screen 845 shown in FIG. 29(a) that enables the initiation of a school or school district-wide search for students of a particular Status, e.g., Emergency Housing 846 as shown in the figure. The search result for students associated with the example selected Emergency Housing code results in list 847 generated for the display screen 848 shown in FIG. 29(b).

Student attendance is a critical factor in meeting educational objectives and in determining funding for sponsored programs. Both the accuracy and the completeness of the attendance records are important and the eSD® system supports both of these objectives.

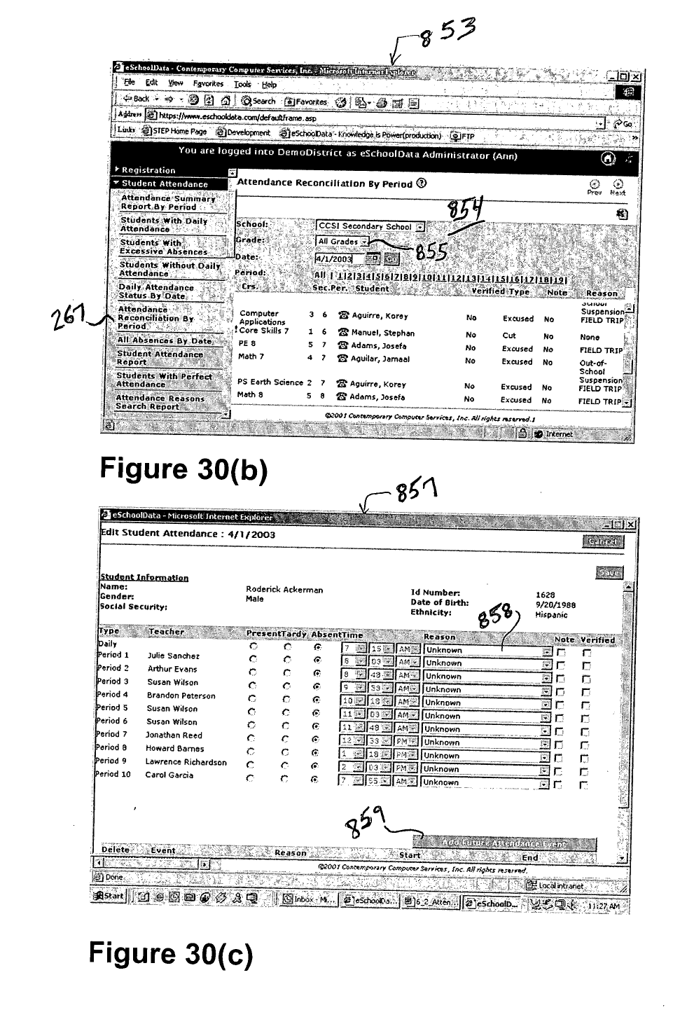

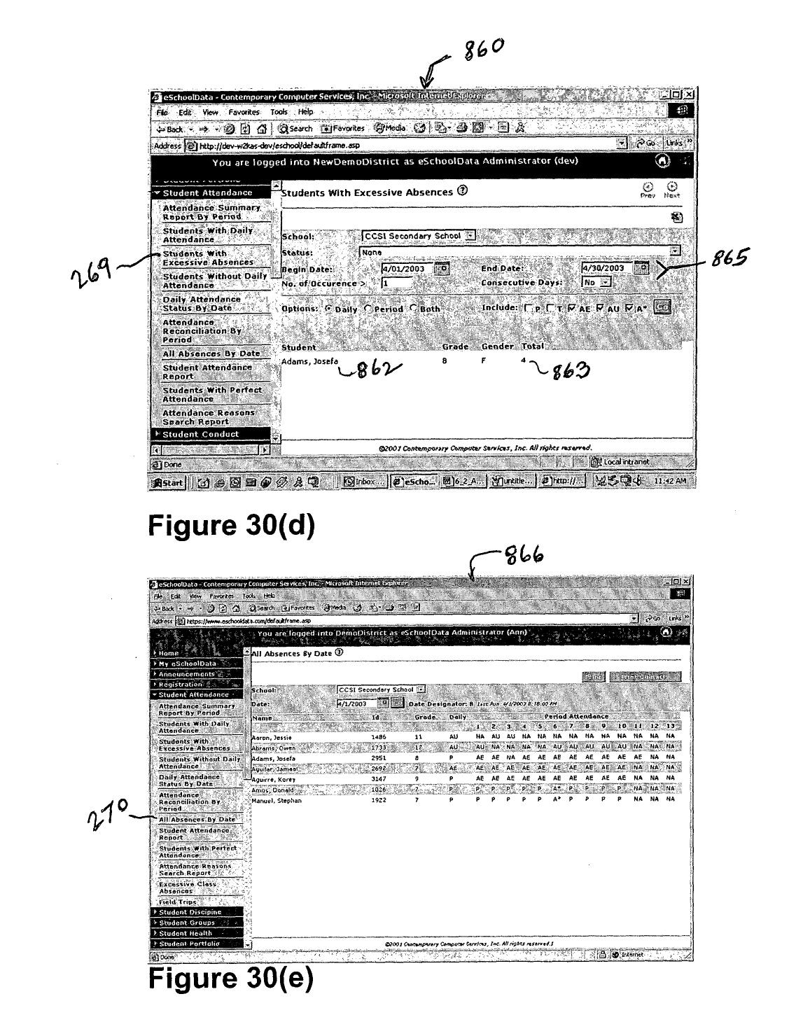

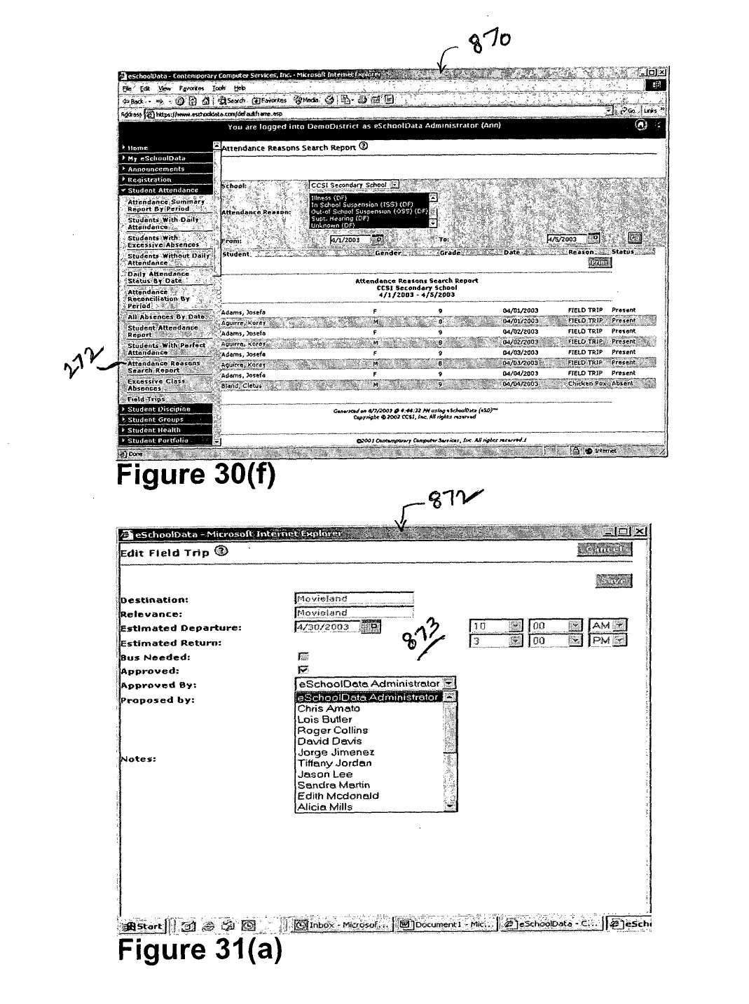

Referring back to FIG. 7(a), a teacher enters daily attendance by selecting a class, and then selecting Today's Attendance 437 from the pop-up menu 435 that appears. As mentioned herein with respect to FIG. 7(b), an exemplary class attendance information screen 440a is displayed that includes the class roster from which the teacher may mark students tardy or absent. For ease of use, all students are marked present by default, however, when a student is marked tardy, a box 443 appears so the teacher can record the time that the student arrived as described herein with respect to FIG. 7(c). This provides the flexibility to customize the system to adhere to a school district established attendance policy, which often provides that lateness greater than a certain period of time, such as 10 minutes, be counted as a cut. When the information displayed in FIG. 7(c) is saved, it becomes immediately available to an Attendance Officer who may take action such as contacting a student's home to confirm absences, enter tardy or absence reasons and monitor the attendance. At the end of the day, the periodic attendances are used to determine the daily attendance status in the manner as described herein. To ensure compliance with the district's attendance policies, the eSD® system further provides functions for generating a summary report of the attendance status by period such as the exemplary report 851 generated upon selection of sub-menu item choice 265 and depicted in the example display 850 of FIG. 30(a). Such a report enables an attendance officer to view a summary report of the attendance status by period. As shown in the example report 851 depicted in FIG. 30(a), there is provided a graphic element such as an exclamation mark 852 to identify teachers who have not entered attendance for classes that have already finished. Thus, in the example shown in FIG. 30(a), five teachers have not updated their class attendance records.

The eSD® system further provides functions for generating an Attendance Reconciliation Report such as the exemplary report 854 generated upon selection of sub-menu item choice 267 and depicted in the example display 853 FIG. 30(b). Such a report enables the identification of student absences from classes, for example, for purposes of further investigation. An attendance clerk may use this report to adjust a student's attendance record for any period. For example, if a student is absent for the first period of the day, and the attendance clerk calls home to discover the student is verified as ill by a parent, the attendance clerk may mark the first period attendance record for that student as an excused absence due to illness. As further shown in the Attendance Reconciliation Report 854 depicted in FIG. 30(b), a date selection option 855 is provided that defaults to the current date, but may be changed to another date if necessary. This is useful when a particular period absence is excused several days after the actual absence occurred. In this case, the date of the absence may be entered to reconcile or edit a particular absence record.

When students are absent, the absence must be classified as excused or unexcused, and the reason noted. Reasons that are excused are established by the state, and the eSD® system preloads all the possible reasons. An example screen used for updating attendance records is depicted in FIG. 30(c) which shows a pop-up screen display 857 for editing a student's attendance, and particularly providing all possible excuse reasons from drop-down lists 858. By selecting button 859 from the screen 857 functionality is provided for updating attendance records as depicted in FIG. 30 (c) particularly by enabling an attendance officer to add a future attendance event, for example, if the school learns that the student will be out of school at a future date.

From the menu item choice Student Attendance depicted in FIG. 30(d), a series of reports may be generated that may assist a user, e.g., the Attendance Officer, in reconciling attendance and identifying students whose attendance patterns jeopardize their academic progress. One report entitled “Students with Excessive Absences” may be generated upon selection of sub-menu item choice 269 by a user that enables generates an interface 860 enabling an attendance officer to specify the following: (1) the period that should be covered by the report; (2) the number of absences that are considered excessive; (3) whether the report should covered daily absences, period absences, or both; and (4) whether the absences viewed should be excused, unexcused or both. The exemplary Students with Excessive Absences screen display 860 as depicted in FIG. 30(d) details all students 862 having a total number of excessive absences 863 for a defined time period 865. If greater detail is needed, another report entitled “All Absences by Date” may be generated upon selection of sub-menu item choice 270 that specifies the period-by-period attendance information, whether the absence was excused or unexcused, and whether a note had been received. An exemplary All Absences by Date screen display 866 is depicted in FIG. 30(e). From the All Absences by Date screen display 866 depicted in FIG. 30(e), an asterisk is shown provided in the last row that indicates that a student was absent a period, e.g., period “6”, and the reason has still not been determined, which would provide an indication to an attendance officer that the students may have skipped that class. Another report entitled “Attendance Reason Search Report” may be generated upon selection of sub-menu item choice 272 that enables the determination and viewing of trends in school absences, e.g. for a single day or a range of days. An exemplary Attendance Reason Search Report screen display 870 is depicted in FIG. 30(f).

With respect to the taking of daily attendance history depicted in FIGS. 7(a)-7c), student field trip attendance presents several administrative challenges including: 1) informing the teachers who will be affected know as far in advance as possible when students will miss a scheduled class; and 2) coordinating the attendance-taking so a student who misses a field trip will still be accounted for in each school period. The eSD® system supports both these educational objectives by enabling teachers to create field trip plans and rosters in advance of a field trip and add/drop students from the group. Individual teachers can look forward on their class rosters to determine who will be out of class on certain days.

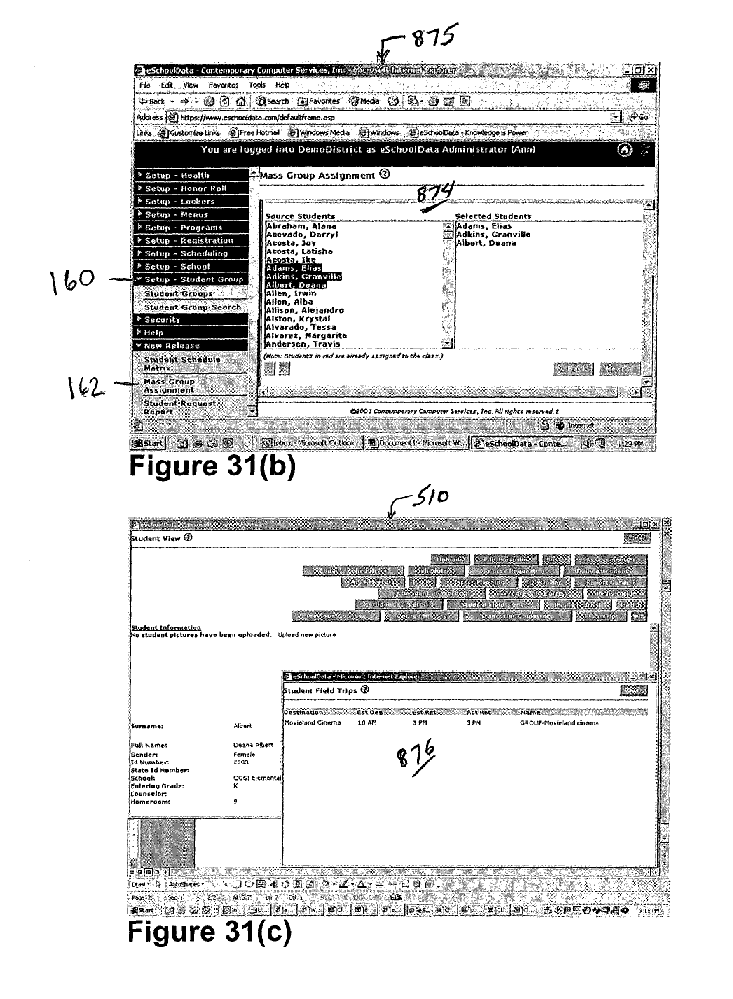

To create field trips in advance, a user selects the menu item choice Custom Codes 146 from eSD® system menu items causes generation of an interface 873 such as illustrated in the exemplary screen 872 shown in FIG. 31(a) that enables the presentation, viewing and editing of all information pertaining to a planned field trip including parameters such as destination, relevance, departure/arrival time, approval authority, etc. After a field trip is planned, students may be mass assigned to the field trip upon selection of sub-menu item choice 162 via an interface 874 shown in the exemplary screen display 875 of FIG. 31(b) that enables a mass group assignment of students to an event, e.g., such as the field trip planned via the interface of FIG. 31(a). After the students are assigned, their attendance status is updated accordingly and is ready for viewing. Thus, by selecting the field trip button 555 from the student profile interface 510 of FIG. 11, an exemplary field trip pop-up screen display 876 such as shown in FIG. 31(c) is generated that illustrates attendance for a planned field trip for that student.

The eSD® system provides three options for scheduling a student within a school. A first option is mass scheduling, i.e., scheduling large groups of students based on course requests that have previously been entered into the system. The second option is mass assignment of students and groups of students directly into classes without the need to enter course requests. A third option is individual scheduling which is available when, for instance, a student enrolls after the fully automated student scheduling has already been run for the school building, or when a student's schedule requires so much modification that it makes sense to “start from scratch.” For mass scheduling, the eSD® system's approach uses an industry standard scheduling engine and involves the following steps: 1) working in eSchoolData, configuring the various parameters such as class meeting times, maximum enrollment rooms, and available staff; 2) Generate Master Schedules (and section the students), and repeating the process until a solid master schedule has been achieved; and, 3) Working in eSchoolData, verifying the schedule, and fine tuning the schedule until it is time to open up for add/drops.

For individual scheduling, the eSD® system provides a way to schedule individual courses for a student by adding each course to a schedule template. The template tracks courses in an easy-to-follow manner by displaying each course in a different color. There is a preview button that allows the user to ascertain at any point in the process which courses have already been scheduled and to see, below the schedule template, which courses remain to be scheduled. Courses that are successfully scheduled are indicated with a “thumbs-up” icon.

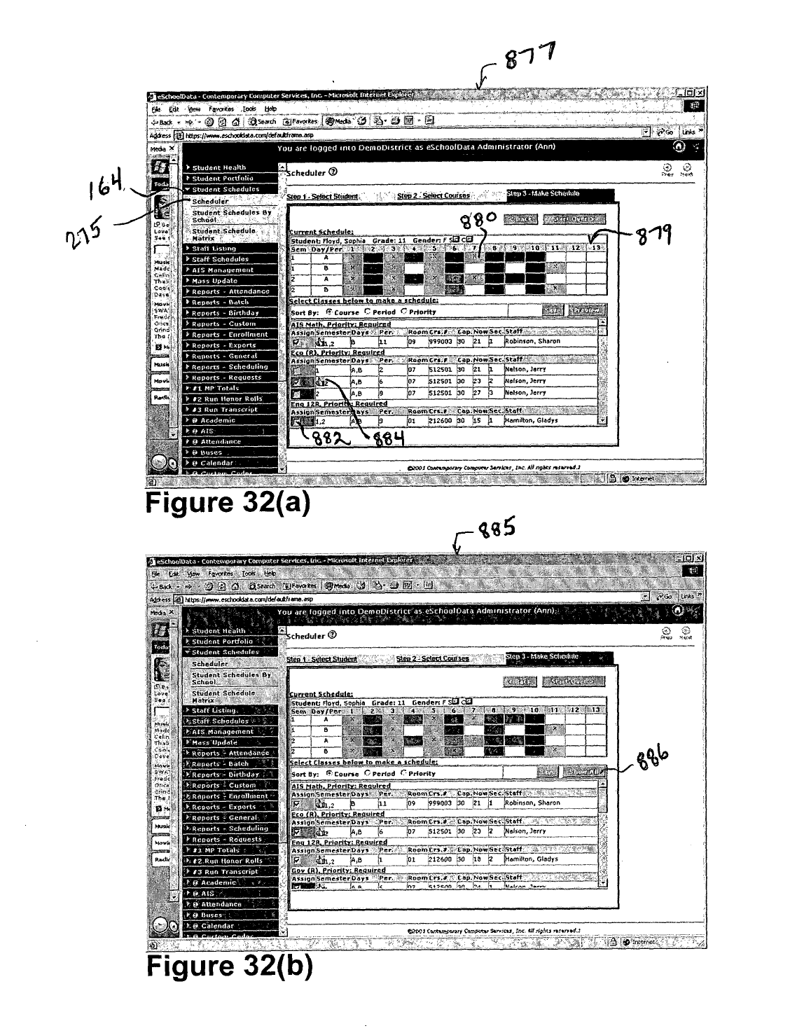

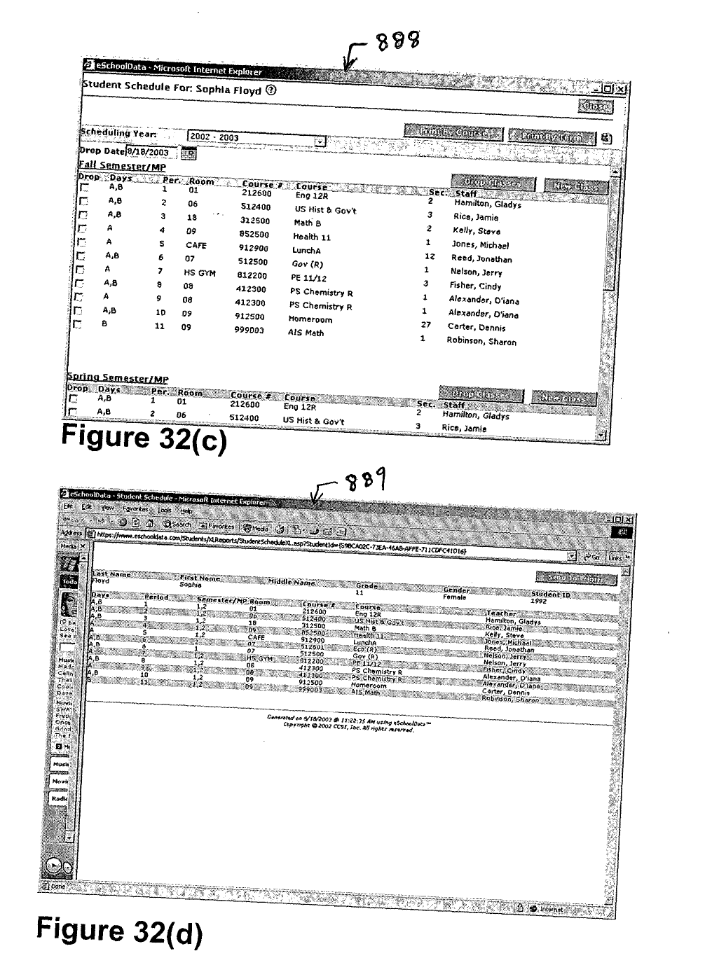

From the menu item choice Student Schedules 164 depicted in FIG. 2(a), there is initiated generation of an exemplary screen 877 shown in FIG. 32(a) and upon selection of the scheduler sub-menu item 275 enables the presentation, viewing and editing of all information pertaining to individual scheduling. According to a preferred embodiment, the courses offered in a school day and period are displayed as a color-coded course listing grid 879 with each color 880 representing a course during a period that may be assigned. Course assignments for an individual student are made via selection boxes 882 each of which corresponds to a color for association with the corresponding color shown in the course listing grid 879 of FIG. 32(a). Thus, from the grid 879, courses may be selected by name or course code. Course selection by name is performed from a drop-down list to eliminate typographical errors and, course selection by code will immediately display course name to allow visual confirmation that course code was correctly entered. The color-coding on schedule template provides visual connection between course listing and schedule. Because each class has a unique ID, that unique number is mapped to a color palette and a corresponding unique color is displayed.

As mentioned, when a course is actually assigned (no scheduling conflict), an indication is generated for display, for example, in the form of an icon 884 to indicate which class was successfully assigned. In the exemplary screen display 877 of FIG. 32(a), a thumbs-up icon is associated with example course 512501 (Eco) which is shown as being successfully scheduled to a student for second semester, period 6. The eSD® system software prevents scheduling conflicts by not allowing two classes to be scheduled for the same time period.

FIG. 32(b) illustrates a generated web-based display 885 providing a preview mode, showing only scheduled classes for a particular student. If a user wants to make changes, the user clicks “Show All” button 886 to view all classes of a course.

From the system, students can be located at any time by looking at the student's schedule which information is available via selection of the Today's Schedule and Schedule(s) choices 523, 525 from the Student Portfolio portal 510 such as shown in FIG. 11. The system can display the schedule by term, e.g., fall semester, such as shown in the exemplary screen display 888 of FIG. 32(c), or by course such as shown in the exemplary screen display 889 of FIG. 32(d).

Currently, schools receive funding based on the following information: type of school, academic performance, wealth, funding sources, funding uses, ethnic and geographic distribution of student population, % of ESL students, percentage of Special Education students, and length of time in the districts, attendance, number of days in session, number of conference days, number of shortened sessions due to emergency conditions, % of student drop outs, % of students participating in the free/reduced lunch program, number of violent and disruptive incidents, student's post-graduate plans, staff certification, etc. Since the eSD® system stores this information at the lowest level of detail, the system automatically produces the required reports in the required format.

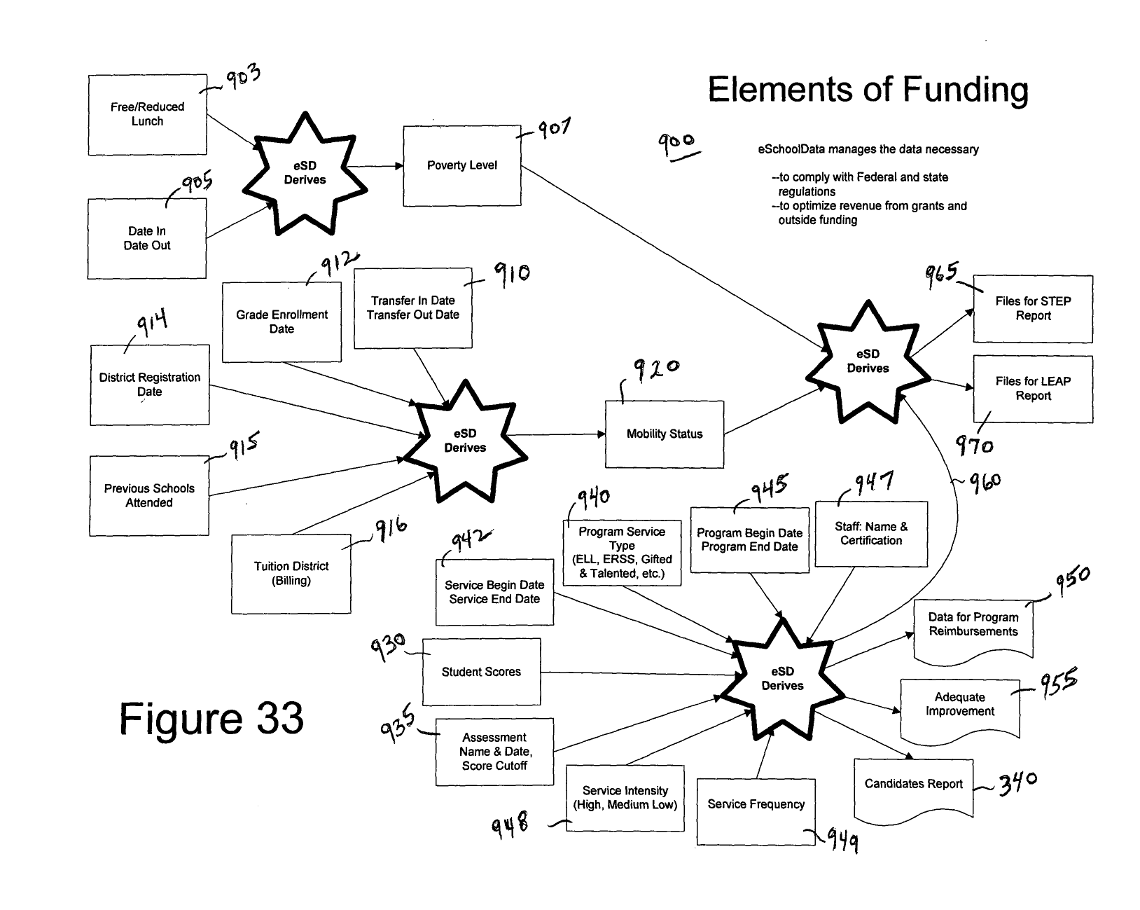

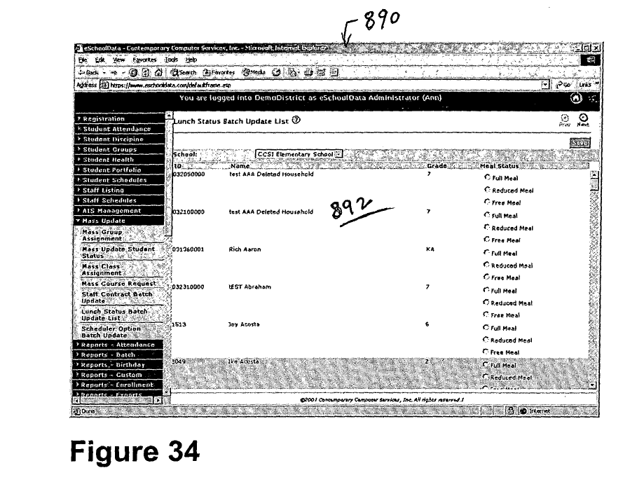

FIG. 33 depicts an overview 900 of the elements of school funding and how the eSD® system manages all of the data necessary to comply with Federal and state regulations and optimize revenue from grants and outside funding sources. As shown in FIG. 33, all the data input to the eSD® system and residing in the system in the proper places on files prepared by the system are used by the performance Assessment, management and reporting thread 45 (FIG. 1(b)) in determining funding, and assist educators in assessing adequate improvement, assembling data needed to request program reimbursements for special grant programs, and in identifying candidates who need services. For example, household income determines eligibility for free or reduced meals. Based on forms filed by the household and/or information known to the district, students may be tagged as eligible for free or reduced lunch. This information 903 (FIG. 33) is retained by the eSD® system as depicted in the exemplary screen display 890 of FIG. 34 which depicts a Lunch Status Batch update list 892 of all students eligible for receiving free or reduced lunch. Referring back to FIG. 33, coupled with the data including dates 905 of when students became eligible for reduced or free lunch 903 a poverty level 907 of a student may be determined by the system. It should be understood however, that poverty guidelines are different for different areas, and are issued each year in the Federal Register by the United States Department of Health and Human Services (HHS). The family is defined by the eligible parent(s) and the size of the family unit and income are self-reported by the eligible parent(s). From other data maintained by the system as described herein including: Student Transfer In/Out dates 910, Grade enrollment dates 912, district registration dates 914; previous schools attended dates 915, and the tuition district (billing code) 916, a mobility status 920 of a student may be determined by the system. A student's mobility status, for example, may be based on data from the student enrollment log. For example, students who come into the school district after October and/or students who leave and come back during the school year may be considered “transient”. Furthermore, from data maintained by the system including: student scores 930, assessments including name, dates and score cutoffs 935, program service types offered (ELL, ERSS, gifted and talented students, etc.) 940 including service begin/end dates 942, program begin/end dates 945 and the type of staff assigned to program 947; service intensity level 948 which appears on the AIS Summary Report when a student is put into an AIS program, and is assigned a level when the student gets an AIS plan; and service frequency 949 which is an attribute of academic intervention services (AIS) having values established by the school district, a variety of reports may be generated by the eSD® system that are used for state reporting and document eligibility for funding. For example, one document includes the above-described candidates report 340, which details students potential eligibility for receiving AIS services as described herein with respect to FIG. 14(a). Another document includes a Data for program reimbursement report 950 which details a program duration (start date and end date), the number of students in the program, the services provided—type of service, frequency, intensity and the type of staff assigned to program 940. Another type of report includes an Adequate Improvement report 955 which according to the mandates of the Federal No Child Left Behind (NCLB) legislation, must provide detailed report on students' demonstrated adequate yearly improvement who are performing below the standard. One example of this Federally mandated report is that schools must provide the most recent 2-year trend in student achievement in each subject area, and for each grade level, for the required assessments. From the derived poverty level 907, mobility status 920 and data 960 maintained for report generation, the eSD® system maintains files that facilitate the automatic generation of reports such as, for example, the above-defined STEP report 965 and LEAP reports 970 as required by a governmental authority (e.g., New York State).

For example, in order to comply with NCLB requirements, each state must develop its own system of accountability to assure student success. In New York State, one element of this system is called the System for Tracking Educational Performance (STEP) report. According to the invention, STEP reporting is fully automated. By selecting the menu item choice Reports 128b from FIG. 2(a) there is generated a window 965 shown in FIG. 19(a) enabling selection of a type of report which may be selected for automatic generation according to the invention. For instance, FIG. 19(a) illustrates the processing of a STEP report generated in response to user selection of STEP report sub-menu item choice 280. After the user selects the process, the system uses selection criteria defined by New York State to identify students who should be included in the report. A student's demographic data, academic information, post-graduate plans and special services are coded according to state standards. After the process is complete, the files are automatically zipped so the user can save them to his local hard drive in the format required for State reporting. For STEP reporting, the three files required are as follows: 1) Demographic.txt; 2) Assessment.txt; and 3) ProgramServices.txt. The STEP report is an example of the eSD® system's unique ability to produce state reports using the baseline elements stored in the system. However, via selection of the menu item choice Reports 128b from FIG. 2(a), the system further enables automatic processing and generation of a LEAP report 970 an exemplary report of which is shown in FIG. 19(b); an AT6 report 972 an exemplary report of which is shown in FIG. 19(c); an SA129 report 975a, 975b an exemplary report of which is shown in FIGS. 19(d) and 19(e) respectively; a Daily Attendance Closeout Report 575 an exemplary report of which is shown in FIG. 19(f); and, a Basic Educational Data Statistics (BEDS) Report 980 an exemplary report of which is shown in FIG. 19(g) which may be run at anytime for the entire district or for an individual school or for a group of schools, such as all schools with a fourth grade.

The eSD system maintains student attendance, health, discipline, and academic profiles for the entire K-12 lifecycle but it uniquely validates, organizes and distributes data to ensure consistency. In the past, school administrators have been burdened with the task of preparing complex reports which are compiled at the State level and used to produce school report cards. School Report cards are widely published and have a direct influence on real estate values in the school community; however, in order to utilize this information efficiently, schools need fingertip access to student level performance data not just aggregate results. The eSD® system enables administrators and classroom teachers alike to have instant, fingertip access to individual student's current and historical performance data.

While the invention has been particularly shown and described with respect to illustrative and preferred embodiments thereof, it will be understood by those skilled in the art that the foregoing and other changes in form and details may be made therein without departing from the spirit and scope of the invention that should be limited only by the scope of the appended claims.

Having thus described our invention, what we claim as new, and desire to secure by Letters Patent is:

1. A web-based knowledge management system for an education system comprising:
means for receiving and storing information including student profile data of each student enrolled in an educational institution, said profile data including a students' demographic information, each student's daily attendance history while said student is enrolled in said education institution, and academic performance data of each student while enrolled in said educational institution;
means for integrating said profile, attendance and academic performance data for each student in said education institution in a manner such that academic growth of each student in said education institution may be monitored over a period of time,
wherein said integrating means relates informational aspects of an educational system to enable objective assessment of the effectiveness of programs instituted in said educational institution at the student, classroom, school, district, and state governmental levels.

2. The web-based knowledge management system for an education system as claimed in claim 1, further comprising automated report generating means for extracting said stored data and generating reports at various levels of detail conforming to guidelines established by any of said hierarchy of governmental authorities.

3. The web-based knowledge management system for an education system as claimed in claim 2, wherein said guidelines established by a governmental authority include. academic standards requirements and performance indicators, said system relating academic growth of each student in said education institution to said academic standards requirements and performance indicators.

4. The web-based knowledge management system for an education system as claimed in claim 2, wherein said guidelines established by a governmental authority include use of codes representing various aspects of students demography, student enrollment, or educational institution funding criteria, said system further comprising means for managing codes such that generated performance reports automatically indicate codes suitable for the guideline established by a governmental authority.

5. The web-based knowledge management system for an education system as claimed in claim 4, further comprising means enabling creation of custom codes associated with a particular group of students having a similar demographic or characteristic, said means for managing codes further enabling tracking of custom codes such that performance reports automatically indicate custom codes suitable for the use by the local educational institution level.

6. The web-based knowledge management system for an education system as claimed in claim 2, wherein each student's recorded daily attendance history while said student is enrolled in said education institution includes recorded reasons for a student's absence for time durations corresponding to a period or a day.

7. The web-based knowledge management system for an education system as claimed in claim 2, wherein each student's daily attendance history while said student is enrolled in said education institution includes recorded field-trip information.

8. The web-based knowledge management system for an education system as claimed in claim 2, further comprising scheduling means for establishing each said student's schedule for receiving education instruction and attending activities at said educational institution, said system enabling tracking of a student to a teacher or activity at any time of day while said student is enrolled in said education institution.

9. The web-based knowledge management system for an education system as claimed in claim 8, further comprising means enabling receipt and storage of anecdotal information about a student, said profile data including a students' anecdotal information entered.

10. The web-based knowledge management system for an education system as claimed in claim 2, further comprising means for performing a daily closeout that translates each student's periodic attendance status into one daily attendance status according to a rule established by the educational institution.

11. A system for enabling an education system to assess student performance in relation to performance criteria mandated by a governmental authority, said system comprising:
a means enabling entry of data by authorized personal in an educational institution, said data including information including student profile data of each student enrolled in an educational institution, including that students' demographic information, each students daily schedules of instruction and activity, each student's daily attendance history while said student is enrolled in said education institution, and academic performance data of each student while enrolled in said educational institution;
a means enabling storage of said student profile data entered by said authorized personnel of said educational institution, said storage means relating aspects of entered student profile data to facilitate automatic access of said data for each enrolled student at one or more levels of detail;
a means for tracking of data entered by authorized personal in an educational institution such that a student may be tracked to a teacher or activity at any time of day while said student is enrolled in said education institution; and,
a means enabling receipt and storage of storing performance criteria in the form of academic standards requirements and performance indicators mandated by said governmental authority; and,
an automated report generating means enabling a user to extract said relationally stored data and generating reports concerning said education institution at said one or more levels of detail, said reports providing information relating each students' performance at said educational institution to academic standards requirements and performance indicators as mandated,
wherein an objective assessment of said education institution may be provided for said governmental authority with increased accuracy.

12. The system as claimed in claim 11, wherein a plurality of education institutions comprise a school district, said automated report generating means enabling extraction of said relationally stored data to generate performance reports suitable for reporting on assessment of said school district.

13. The system as claimed in claim 11, wherein said means for enabling storage of said student profile data includes means enabling storage of data pertaining to a student from sources outside said educational institution said student is currently enrolled in.

14. The system as claimed in claim 13, wherein an outside source of data includes data pertaining to said student from a prior education institution that a student may have been enrolled in whether from a same or another school district.

15. The system as claimed in claim 11, wherein said academic standards requirements and performance indicators are represented as codes issued by a governmental authority, said system further including means for automatically associating data pertaining to a student's performance with a code suitable for a report generated for a particular governmental authority.

16. A method for improving an educational system comprising the steps of:
inputting and storing data at various levels of detail including:
school site profile information regarding said educational system;
student profile information including demographic information relating to said enrolled student, a student's daily attendance history while said student is enrolled at said school, and academic performance data of each student while enrolled in said school, said data being including required data elements at said various levels of detail so as to capture a school's workflow with regard to registration, attendance, scheduling, discipline, academic performance and reporting;
integrating said student profile, attendance and academic performance data for each student in said education institution to enable monitoring of academic growth of each student in said school while attending said school in said system;
concurrently receiving and incorporating data relating to current and impending regulations and accountability requirements as established by state and federal governmental authority; and,
relating informational aspects of said educational system with said student profile information to provide an improved assessment of the effectiveness of programs instituted in said educational institution, and automatically complying with any new accountability reporting requirements established.

17. The method as claimed in claim 16, further comprising the step of: extracting said stored data and automatically generating reports means at various levels of detail conforming to guidelines established by any level of state government.

18. The method as claimed in claim 16, further comprising the step of automatically identifying students in a school requiring academic support services based on individual school district policies and governmental requirements.

19. The method as claimed in claim 16, further comprising the step of automatically identifying students eligible for academic enhancement services based on individual school district policies and governmental requirements.

20. A method for increasing the funding potential of an educational system:
receiving and storing data at various levels of detail including:
school site profile information regarding said educational system; and
student profile information including demographic information relating to said enrolled student, a student's daily attendance history while said student is enrolled at said school, and academic performance data of each student while enrolled in said school, said data being including required data elements at said various levels of detail so as to capture a school's workflow with regard to student registration, attendance, discipline, and reporting;
integrating said student profile, attendance and academic performance data for each student in said education institution to enable monitoring of academic growth of each student in said school while attending said school in said system;
automatically assigning a daily attendance status for every student in said educational system based on the periodic attendance statuses and any rule received relevant to student attendance from said school site profile information; and,
from said assigned daily attendance statuses, generating accurate student attendance reports for periods relevant to determination of funding potentials,
wherein said funding potential of an educational system is based upon said accurate student attendance reporting.

21. The method as claimed in claim 20, further comprising the step of automatically identifying students eligible for academic enhancement services based on individual school district policies and governmental requirements.

22. The method as claimed in claim 20, further comprising the step of determining a student's poverty level from student registration information collected about that student's household.

23. The method as claimed in claim 21, further comprising the step of determining a student's mobility status poverty level from student registration information collected about that student's enrollment dates.

24. A method for enabling an education system to assess student performance in relation to performance criteria mandated by a governmental authority, said method comprising steps of:
enabling entry of data by authorized personal in an educational institution, said data including information including student profile data of each student enrolled in an educational institution, including that students' demographic information, each students daily schedules of instruction and activity, each student's daily attendance history while said student is enrolled in said education institution, and academic performance data of each student while enrolled in said educational institution;
enabling storage of said student profile data entered by said authorized personnel of said educational institution,
relating aspects of entered student profile data to facilitate automatic access of said data for each enrolled student at one or more levels of detail;
tracking of data entered by authorized personal in an educational institution such that a student may be tracked to a teacher or activity at any time of day while said student is enrolled in said education institution; and,
enabling receipt and storage of storing performance criteria in the form of academic standards requirements and performance indicators mandated by said governmental authority; and,
extracting said relationally stored data and generating reports concerning said education institution at said one or more levels of detail, said reports providing information relating each students' performance at said educational institution to academic standards requirements and performance indicators as mandated, wherein an objective assessment of said education institution may be provided for said governmental authority with increased accuracy.

25. A program storage device readable by a machine, tangibly embodying a program of instructions executable by the machine to perform method steps for enabling an education system to assess student performance in relation to performance criteria mandated by a governmental authority, said method comprising the steps of:
enabling entry of data by authorized personal in an educational institution, said data including information including student profile data of each student enrolled in an educational institution, including that students' demographic information, each students daily schedules of instruction and activity, each student's daily attendance history while said student is enrolled in said education institution, and academic performance data of each student while enrolled in said educational institution;
enabling storage of said student profile data entered by said authorized personnel of said educational institution,
relating aspects of entered student profile data to facilitate automatic access of said data for each enrolled student at one or more levels of detail;
tracking of data entered by authorized personal in an educational institution such that a student may be tracked to a teacher or activity at any time of day while said student is enrolled in said education institution; and,
enabling receipt and storage of storing performance criteria in the form of academic standards requirements and performance indicators mandated by said governmental authority; and,
extracting said relationally stored data and generating reports concerning said education institution at said one or more levels of detail, said reports providing information relating each students' performance at said educational institution to academic standards requirements and performance indicators as mandated, wherein an objective assessment of said education institution may be provided for said governmental authority with increased accuracy.

26. A program storage device readable by a machine, tangibly embodying a program of instructions executable by the machine to perform method steps for improving an educational system, the method comprising the steps of:
inputting and storing data at various levels of detail including:
school site profile information regarding said educational system;
student profile information including demographic information relating to said enrolled student, a student's daily attendance history while said student is enrolled at said school, and academic performance data of each student while enrolled in said school, said data being including required data elements at said various levels of detail so as to capture a school's workflow with regard to registration, attendance, scheduling, discipline, academic performance and reporting;
integrating said student profile, attendance and academic performance data for each student in said education institution to enable monitoring of academic growth of each student in said school while attending said school in said system;
concurrently receiving and incorporating data relating to current and impending regulations and accountability requirements as established by state and federal governmental authority; and,
relating informational aspects of said educational system with said student profile information to provide an improved assessment of the effectiveness of programs instituted in said educational institution, and automatically complying with any new accountability reporting requirements established.
